(19) United States
(12) Patent Application Publication
(10) Pub. No.: US 2024/0196856 A1
(43) Pub. Date: Jun. 20, 2024

(54) ERGONOMIC LITTER DEVICE

(71) Applicant: Automated Pet Care Products, LLC, d/b/a Whisker, Auburn Hills, MI (US)

(72) Inventors: Jason Smith, West Bloomfield, MI (US); Brad Baxter, Bloomfield Hills, MI (US)

(21) Appl. No.: 18/594,372

(22) Filed: Mar. 4, 2024

Related U.S. Application Data
(63) Continuation of application No. 17/509,866, filed on Oct. 25, 2021.
(60) Provisional application No. 63/104,574, filed on Oct. 23, 2020.
(60) Provisional application No. 63/104,604, filed on Oct. 23, 2020.
(60) Provisional application No. 63/104,625, filed on Oct. 23, 2020.

(51) Int. Cl. A01K 1/01

(52) U.S. Cl. CPC A01K 1/0114

(57) ABSTRACT

A litter device which is easily operable by individuals with limited mobility or disabilities. A litter device having a base; a waste drawer removably located within the base; a chamber with an entry opening, wherein the chamber is configured to retain litter, is supported by the base, and is located above the waste drawer; and a lift affixed to the base, the waste drawer, or both, wherein the lift is configured to raise and lower the base, the waste drawer, or both.

### CROSS REFERENCE TO RELATED APPLICATIONS

This application claims priority from U.S. Provisional Application Nos. 63/104,574, 63/104,604, and 63/104,625, each filed on Oct. 23, 2020, and which are incorporated herein by reference in their entirety for all purposes.

### FIELD

The present teachings generally relate to a litter device for use by animals which removes animal waste from litter. The litter device may be particularly ergonomically friendly and useful by those with limited mobility.

### BACKGROUND

Automated litter devices may provide a means for pet owners (e.g., user) to effectively manage waste eliminated by one or more of their pets. These automated litter devices may be advantageous in automatically removing waste contents from litter; automatically collecting waste for subsequent disposal; storing waste contents separate from a litter chamber such that they are not exposed to the ambient environment, thereby preventing and/or reducing smell from the waste. Examples of some automated litter boxes which may be particularly beneficial may be found in U.S. Pat. Nos. 6,463,881; 8,757,094; and 9,433,185; US Publication No: 2019/0364840; PCT Patent Application No.: PCT/US2020/029776 (published as PCT Publication No. WO 2020/219849A1); and US Provisional Application Nos.: 63/104,574 and 63/104,604 which are incorporated by reference herein in their entirety for all purposes and can be modified to include any of the featured described herein.

Domestic animals, and more so typically felines, are excellent companions for elderly and disabled individuals. Felines are generally low maintenance and lower energy than canines. Felines are also compatible with individuals having limited mobility. One challenge with respect to caring for a cat for those with limited mobility is litter box maintenance. Both typical and automated litter boxes may be low to the ground, which may place litter out of, or at an extended and uncomfortable, reach for elderly individuals, those with back problems, or anyone with limited mobility. Due to the extended reach, cleaning and refilling litter may require too much force or effort to clean for an individual with constraints. Automated litter boxes, such as the ones identified hereinbefore, while resolving some of these challenges, may still be difficult to maneuver for those with limited mobility.

Another concern with automated litter boxes, is that while they alleviate many of the concerns of daily manual cleaning of a standard litter box, they still have a limited capacity for retaining waste. There is a need for providing additional waste storage space to allow pet owners additional scheduling flexibility while providing a sanitary litter device which an animal is comfortable using.

Further, while automated litter boxes are quite advantageous, some consumers are not able to afford the automation technology for an automated litter device. What is needed is a manually operable litter device which functions similar to an automated litter device and has many of the same advantages of an automated litter device.

### SUMMARY

The present teachings relate to a litter device comprising: a) a base having a waste drawer; b) a chamber with an entry opening configuring for retaining litter and supported by the base; and c) optionally, a lift located below the base, a waste drawer, or both.

The present teachings relate to a litter device comprising: a) a base; b) a waste drawer removably located within the base; c) a chamber with an entry opening, wherein the chamber is configured to retain litter, is supported by the base, and is located above the waste drawer; and d) a lift affixed to the base, the waste drawer, or both, wherein the lift is configured to raise and lower the base, the waste drawer, or both.

The present teachings relate to a litter device comprising: a) base; b) a waste drawer removably located within the base; c) a chamber with an entry opening, wherein the chamber is configured to retain litter, is supported by the base, and is located above the waste drawer; d) a lift affixed to the base, the waste drawer, or both, wherein the lift is configured to raise and lower the base, the waste drawer, or both; and e) a user interface which includes one or more speakers, microphones, buttons, screens, or a combination thereof.

The present teachings relate to a litter device comprising: a) a base; b) a waste drawer removably located within the base; c) a chamber configured to retain litter, wherein the chamber is rotatably supported by the base and is located above the waste drawer, and wherein the chamber includes: i) an entry opening so that an animal can enter and exit the chamber; and ii) a waste opening configured so that animal waste passes through the waste opening into the base upon rotation of the chamber; d) a bezel located about the entry opening; e) one or more sensors located on an upper portion of the bezel and which have a line of sight into the chamber; f) a lift affixed to the base, the waste drawer, or both, wherein the lift is configured to raise and lower the base, the waste drawer, or both; and g) a user interface which includes one or more speakers, microphones, buttons, screens, or a combination thereof, and wherein the user interface is affixed to the bezel, the base, a bonnet, or a combination thereof.

The litter device of the present teachings may comprise one or more of the following features in any combination: the lift may be static and/or moveable; the lift may be moveable between a lowered position and a raised position; the lift may include one or more steps on an exterior; the lift may include a storage drawer; the lift may be hydraulic, pneumatic, self-leveling, electric, manual, or a combination thereof; the lift may be manual and/or automatic; the lift may be separate from or integrated with the base, the waste drawer, or both; the lift may include a base support, a platform, one or more legs, one or more movement aids, the like, or a combination thereof; the lift may be a scissor lift, vertical ram platform lift, or both; the litter device may include a user interface; the user interface may include a speaker, microphone, or both; the user interface may include one or more user input devices; the one or more user input devices may include one or more buttons, microphones, graphic user interfaces, or any combination thereof; the user interface may be part of a bonnet, bezel, base, chamber, the like, or a combination thereof; may include a bezel surrounding the entry opening; the user interface may be integrated into the bezel; the waste drawer may be expandable; the waste drawer may be configured to expand by telescoping, accordion folding, the like, or a combination thereof; the litter device may include one or more sensors; the one or more sensors may be located adjacent to an entry opening; the one or more sensors may be adapted to sense a presence of an animal within the chamber, a presence of a waste in a waste bin in the base, a level of the litter in the chamber, a position of the chamber relative to the base, or any combination thereof; the litter device may include a bezel located about the entry opening; the one or more sensors may be located on an upper portion of the bezel which have a line of sight into the chamber; at least one of the one or more sensors may have a line of sight into the waste drawer via a waste opening of the chamber; at least one of the one or more sensors may have a line of sight into the waste drawer via the waste opening when the chamber rotates such that the waste opening is aligned with the waste drawer; the litter device may include one or more mass sensors configured to sense a mass of at least a portion of the litter device; the one or more mass sensors may be affixed to and/or part of one or more feet of the base, the lift, or both; the waste drawer may be configured to automatically and/or manually expand; the waste drawer may include a waste leveler; the waste leveler may be configured to move the waste drawer to level the waste within the waste drawer; the waste leveler may include a vibration platform in communication with or integrated with the waste drawer; the chamber may include a screen configured to sift through the litter and separate the waste from the litter; wherein the chamber, screen, or both are configured to be rotatable to filter the litter; the litter device may include a drive source; the drive source may be manual, automated, or both; the drive source may include a hand crank or motor; the litter device may include a waste bag sealer; the waste bag sealer may be configured to permanently and/or temporarily close a waste bag prior to removable from the litter device; and the waste bag sealer may include: a heated jaw sealer, heat sealing iron, quick bag seal closer, heat crimper, electric impulse sealer, heat roller, automatic twister, the like, or any combination thereof.

The present teachings may provide for a litter device which allows for those with limited mobility to more easily access and empty a waste drawer. The presenting teachings may provide for a lift part of the litter device which is capable of easily being raised into a higher position. The waste drawer being lifted may allow for a user to reach within a waste drawer, such as for a bag of collected waste, without having to reach close to the ground or lift weight from close to the ground. A lift may allow for one or more portions of the litter device to be raised for emptying of waste while allowing for the litter device to be lowered to a height suitable for domestic animals to access. The present teachings may provide for an expandable waste drawer, waste leveler, or both which may allow for the waste capacity of a waste drawer to be more efficiently utilized or even increased. The present teachings may provide for one or more manual mechanisms for operating a litter device while still sharing many benefits of an automated litter device. These benefits may include sifting the litter without a user having to reach into the litter themselves, collecting waste in a waste drawer, sealing away the waste and malodors, the like, or any combination thereof.

### BRIEF DESCRIPTION OF DRAWINGS

FIG. 1 is a perspective view of a litter device.

FIG. 2 is a front view of a litter device.

FIG. 3 is a top view of a litter device.

FIG. 4A is a side view of a litter device with a lift in a compressed position.

FIG. 4B is a side view of a litter device with a lift in an extended position.

FIG. 5A is a side view of a litter device with a lift in a compressed position.

FIG. 5B is a side view of a litter device with a lift in an extended position.

FIG. 6A is a side view of a waste drawer with a lift in a compressed position.

FIG. 6B is a side view of a waste drawer with a lift in an extended position.

FIG. 7A is a side view of a litter device with a waste drawer in an open position with a lift in an extended position.

FIG. 7B is a cross-section of a slide device as shown in FIG. 7A.

FIG. 8A is a side view of a litter device with a storage unit.

FIG. 8B is a front view of a litter device with a storage unit.

FIG. 9 is a front view of a litter device with a user interface.

FIG. 10 is a front view of a litter device with a user interface.

FIG. 11 is a cross-section side view along section A-A of FIG. 2 exposing an interior of a litter device with an expandable waste drawer.

FIG. 12 is a cross-section side view along section A-A of FIG. 2 exposing an interior of a litter device with one or more sensors.

FIG. 13 is an exploded view of a litter device.

FIG. 14A is a rear view of a litter device.

FIG. 14B is a bottom view of a litter device.

FIG. 14C is a right side view of a litter device.

FIG. 14D is a left side view of a litter device.

FIG. 15A is a left side view of a litter device with a bonnet removed.

FIG. 15B is a right side view of a litter device with a bonnet and base frame removed.

FIG. 16 is a perspective view of a base.

FIG. 17 illustrates a cross-section along section A-A of FIG. 2 of a litter device.

FIG. 18A is a front view of a litter device.

FIG. 18B is a cross-section view exposing an interior of a base of the litter device.

FIG. 19A is a perspective view of an automatic litter device.

FIG. 19B is a left side view of an automatic litter device.

FIG. 19C is a rear view of an automatic litter device.

FIG. 20A is a left side view of an automatic litter device.

FIG. 20B is a front view of an automatic litter device.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Litter Device

The present teachings relate to a device that includes litter for use by an animal. The device may be a litter device. The litter device may be an automated litter device. The device may function to retain litter, sort used litter from unused litter, collect animal waste, remove animal waste, divide animal waste from litter, temporarily store animal waste, or any combination thereof. The device may have the ability to replace used litter with unused litter. The device may be useful by one or more domesticated animals. One or more domesticated animals may include one or more cats, rabbits, ferrets, pigs, dogs, ducks, goats, foxes, the like, or any combination thereof. The device may be compatible with one or more types of litter. One or more types of litter may include clumping clay, non-clumping clay, silica gel crystals, recycled paper, pine, corn wheat, walnut shells, the like, or any combination thereof.

The litter device includes a chamber. The chamber may function to house clean litter, provide a space for an animal to enter and excrete waste, or both. The chamber may have any size and shape which is able to retain sufficient litter for an animal to use during waste elimination, allow for an animal to comfortably use the litter box, or both. The chamber may have a three-dimensional shape which is substantially spherical, ovoidal, cylindrical, cuboidal, conical, pyramidical, the like, or any combination thereof. A shape which is substantially spherical, ovoidal, cylindrical, and/or the like may be beneficial in providing for rotation of the chamber during a cleaning cycle, avoiding litter and/or waste from collecting along one or more vertices, or a combination thereof. For example, the chamber may be shaped like a globe, sphere, football, egg, the like, or a combination thereof. The chamber may be capable of rotation during a cleaning cycle. The chamber may be rotatably or statically supported by a base. The base may be located between the chamber and a surface upon which the litter device rests. The chamber may have a generally hollow interior to accommodate one or more septums, liners, litter, and the like. The chamber may include an entry opening, waste opening, or both. The chamber may have a generally hollow interior to accommodate one or more animals during use. The chamber may have a size which is able to accommodate one or more animals which are about 1 kg or greater, about 2 kg or greater, about 4 kg or greater, about 8 kg or greater, or even about 10 kg or greater. The chamber may have a size which is able to accommodate one or more animals which are about 30 kg or less, about 25 kg or less, about 20 kg or less, or even about 15 kg or less. The hollow interior may form a volume of the chamber. The volume of the chamber may be about 16,000 cm³ or greater, about 32,500 cm³ or greater, or even about 65,000 cm³ or greater. The volume of the chamber may be about 150,000 cm³ or less, about 100,000 cm³ or less, about 85,000 cm³ or less, or even about 75,000 cm³ or less. The chamber may have a volume that is usable by an animal which can fit through an entry opening. The usable volume may be any volume such that the chamber may be used by an animal to excrete waste. The usable volume may be any volume such that an animal can enter, turn, and move around within the chamber. The volume of the chamber may be the usable volume, the total volume, or both. The usable volume may be the volume within the hollow interior of the chamber minus the volume occupied by litter and any components internally located within the chamber. The total volume may be the actual volume of the hollow interior of the chamber. The chamber may be formed by a single piece or a plurality of pieces. The chamber may include one or more filter systems affixed thereto, in fluid communication therewith, or both. The chamber may be formed by a single piece having a substantially spherical shape. The chamber may be formed by two or more pieces which mate to form a substantially spherical shape. The chamber may be formed by an upper chamber and lower chamber.

The chamber may include an upper chamber and a lower chamber. The upper chamber and the lower chamber may function to mate together to form the chamber, an entry opening, or both. The upper chamber and lower chamber may mate together to form a shape and/or size of the chamber. The upper chamber, lower chamber, or both may form 25% of the chamber or greater, 35% of the chamber or greater, or even 50% of the chamber or greater. For example, the upper chamber and lower chamber may each have a shape which is substantially hemispherical. The hemispherical shapes may mate together to form a shape which is substantially spherical, ovoidal, or the like. The upper chamber, lower chamber, or both may house one or more filter systems. The upper chamber, lower chamber, or both may include one or more filter cavities. The one or more filter cavities may function as a filter housing. For example, the lower chamber may include a filter cavity on an underside. An underside may be the surface of the lower chamber facing toward a waste drawer when the chamber is in a home position. The upper chamber, lower chamber, or both may include one or more flanges. The one or more flanges may be formed about one or more rims of the upper chamber, lower chamber, or both. The one or more flanges may mate with one or more other flanges. For example, a flange of an upper chamber may align and mate with a flange of a lower chamber. The upper chamber, lower chamber, or both may have one or more cut-outs, contours, and the like. The upper chamber, lower chamber, or both may have a cut-out which forms a portion of an entry opening. For example, the upper chamber may have a cut-out which forms an upper portion of an entry opening and the lower chamber may have a cut-out which forms a lower portion of an entry opening.

The chamber may include an axis of rotation. The axis of rotation may function as the relative axis about which the chamber, septum, screen, or a combination thereof rotates during one or more cleaning cycles. The axis of rotation may have any orientation such that the usable volume of a chamber is increased; the litter relative to the chamber has a conical rotation; litter is funneled toward a rear of the chamber (e.g., away from the front opening), toward and through a screen and/or septum, or both; a septum and/or screen passes through and sifts through the litter; a larger entry opening may be used without litter spilling therefrom; a screen and/or septum can be located further back in the chamber creating more internal space; or any combination thereof. The axis of rotation of the chamber may form an angle with a vertical plane, horizontal plane, or both. A vertical plane may be substantially in the direction of gravity, parallel to gravity, or both. A horizontal plane may be substantially perpendicular to a direction of gravity, parallel to a surface upon which the litter device rests, or both. The axis of rotation of the chamber may form any angle with a vertical plane, horizontal plane, or both so that one or more of the teachings herein are achieved. The axis of rotation may form an angle of about 88 degrees or less, about 85 degrees or less, about 80 degrees or less, about 75 degrees or less, or even about 70 degrees or less with a vertical plane. The axis of rotation may form an angle of about 40 degrees or greater, about 45 degrees or greater, about 50 degrees or greater, about 55 degrees or greater, about 60 degrees or greater, or even about 65 degrees or greater with a vertical plane. The axis of rotation may form an angle of about 40 degrees to about 88 degrees, of about 55 degrees to about 80 degrees, of about 40 degrees to about 85 degrees, or even about 60 degrees to about 75 degrees with a vertical plane. The axis of rotation may form an angle with the horizontal plane that is complementary to the angle relative to the vertical plane. The angled axis of rotation may funnel clumps of waste and/or litter, waste, or both toward a common location. The common location may be located toward a rear, bottom, or both of the chamber. The common location may be a septum, screen, waste opening, waste bin, or any combination thereof. The axis of rotation may allow for a single waste opening to be used, waste to be funneled toward the waste opening, waste to transfer for the waste opening to a waste bin, or any combination thereof.

The angled axis of rotation along with the frictional characteristics of the litter may result in a litter bed with an angle of repose. The angle of repose may function so that litter is angled away from an entry opening, litter is prevented from spilling from an entry opening, an entry opening may be as large as possible while keeping litter within the chamber, or any combination thereof. The angle of the litter bed may be angled such that the litter is angled away from an entry opening. Angled away from an entry opening may mean that a depth of the litter proximate to an entry opening is smaller than a depth of the litter more distant from the entry opening (e.g., the litter depth increases as the distance of the litter increases from the entry opening). The angle of the litter bed may be any angle such that the ability of an animal accidentally moving litter outside of opening is reduced compared to a litter bed that is free of an angle. Free of an angle may mean about perpendicular to the vertical plane, parallel to the horizontal plane, or both. The angle of the litter bed may form an angle that is about 89 degrees or less, about 88 degrees or less, about 87 degrees or less, or even about 85 degrees or less with the vertical plane. The angle of the litter bed may form an angle that is about 70 degrees or greater, about 75 degrees or greater, or even about 80 degrees or greater with the vertical plane. For example, the angle of the litter bed may be about 75 degrees to about 88 degrees, or even about 80 degrees to about 87 degrees with the vertical plane. The litter bed may rest on any surface of the chamber.

The chamber may include a liner. The liner may prevent direct contact between litter and a chamber interior while the chamber is in a home position. The liner may cover a portion or all of an interior surface of the chamber. The liner may be any size, shape, and/or configuration such that it contacts the litter; retains litter, waste, liquids, solids, semi-solids, or a combination thereof in the chamber. The liner may be any size and/or shape such that it allows the litter resting thereon to absorb, encircle, clump, or a combination thereof to the waste after elimination by an animal. The liner may have a shape substantially reciprocal with the contour of a chamber, upper chamber, lower chamber, or a combination thereof. For example, the liner may have a shape which is substantially hemispherical. The liner may be directly adjacent to and in contact with an interior of the chamber. For example, the liner may be in direct contact with an interior surface of a lower chamber. The liner may be affixed to, free of attachment to, or both to a chamber. The liner may be at least partially affixed to a lower chamber. The liner may be partially free of attachment to any part of the chamber. Free of attachment may allow for the liner to temporarily distance itself from an interior surface of the chamber (e.g., drop, loosen) during one or more cleaning cycles. This distancing motion, whether dropping or loosening or the like, may allow for waste temporarily stuck to the liner to loosen and move toward the waste opening. One or more edges, a central region, or both may be affixed to, free of attachment to, or both to the chamber. For example, the edges of liner may be connected to the chamber while a central region may be free of attachment. The central region free of attachment may drop and/or loosen during a cleaning cycle while the edges remain affixed to the chamber. The liner may include a weight. The weight may function to cooperate with gravity, so the liner partially drops during a cleaning cycle, returns back to resting within the lower chamber when in a home position, or both. The weight may be affixed to, reside in, or both an underside of the liner. The weight may be located between a liner and lower chamber. The weight may be located in a weight cavity within the liner. The underside of the liner may include a weight cavity formed therein. The underside may be the side of the liner facing toward and adjacent to a lower chamber. The weight cavity may have a shape reciprocal with that of the weight. The weight cavity may be spherical, ovoidal, cylindrical, cuboidal, conical, pyramidical, the like, or any combination thereof. The liner may be comprised of a suitable material. The material may be non-stick; liquid impenetrable; resistant to damage, penetration, scent absorption, stain, or a combination thereof by litter, waste, liquids, solids, semi-solids, or a combination thereof. The liner material may be rubber, plastic, a synthetic material, a natural material, or any or a combination thereof.

The chamber includes an entry opening. The entry opening allows for one or more animals to comfortably enter and exit the chamber. The entry opening may be any size and shape so that one or more animals may enter and exit the chamber. The entry opening may be any size and shape so that during entry, use, and/or exiting by an animal; during one or more cleaning cycles; or any combination thereof litter is substantially maintained within the chamber. The entry opening may have a profile shape and/or cross-section which is substantially circular, ovular, elliptical, square, rectangular, trapezoidal, triangular, rhombus, the like, or any combination thereof. The profile shape may be a shape looking at an opening plane straight on, perpendicular, or both. The entry opening may have a profile shape which is symmetrical, non-symmetrical, or both. An entry opening which is circular, ovular, or the like may offer a more comfortable and larger entry area, may avoid sharp vertices that may scratch an animal, may avoid sharp vertices which may catch litter upon exit of the animal from the chamber, or a combination thereof.

The entry opening may form an opening plane. The opening plane may extend along the entry opening (e.g., along a surface that extends from the top of the entry opening to the bottom of the entry opening). The entry opening, the opening plane, or both may form an angle with a vertical plane. The entry opening, opening plane, or both may form an angle with the vertical plane of about 5 degrees or more, about 10 degrees or more, or even about 15 degrees or more, about 18 degrees or more, or even about 20 degrees or more. The entry opening, opening plane, or both may form an angle with the vertical plane of about 60 degrees or less, about 45 degrees or less, about 30 degrees or less, or even about 25 degrees or less. For example, the entry opening, opening plane, or both may form an angle with the vertical plane of about 10 degrees to about 30 degrees. As another example, the entry opening, opening plane, or both may form an angle with the vertical plane of about 15 degrees to about 25 degrees (i.e., about 20 degrees). The angle of the entry opening, opening plane, or both relative to the vertical plane may allow for litter to be maintained within the chamber, the entry opening to be as large as possible while maintaining litter within the chamber, provide a larger interior surface area for a litter bed, allow for one or more sensors to have a line of sight into an interior of the chamber, or any combination thereof.

The entry opening may include one or more axes. The one or more axes may assist in defining the width, height, shape, cross-sectional area, or any combination thereof of the entry opening. The one or more axes may include a primary axis and secondary axis. A primary axis may be substantially parallel with the opening plane, angled relative to the vertical plane and/or horizontal plane, may extend from the top of the entry opening to the bottom of the entry opening, or any combination thereof. The top of the entry opening may be defined as opposite the bottom. The bottom may be defined as a portion closest to the base of the litter device. The primary axis may define a height of the entry opening. A secondary axis may be substantially parallel with the opening plane, perpendicular to the primary axis, parallel with a horizontal plane, may extend from one side to an opposing side, or any combination thereof. The secondary axis may define a width of the entry opening. The length of the primary axis and the length of the secondary axis may form a ratio. The ratio may be such that an animal can comfortably fit within the entry opening to enter and exit the chamber, litter and waste contents remain within the chamber, or both. The ratio of the length of the primary axis to the secondary axis may be about 1:3 or greater, about 1:2.5 or greater, about 1:2 or greater, about 1:1.5 or greater, about 1:1.2 or greater, or even about 1:1 or greater. The ratio of the length of the primary axis to the secondary axis may be about 3:1 or less, about 2.5:1 or less, about 2:1 or less, about 1.5:1 or less, about 1.2:1 or less, or even about 1.1:1 or less. The axis of rotation may run at an angle relative to the primary axis, secondary axis, or both. The axis of rotation may be at an angle acute, perpendicular, or obtuse to the primary axis, secondary axis, or both. The axis of rotation may be at an angle of about 60 degrees or greater, about 70 degrees or greater or even about 85 degrees or greater relative to the primary axis, secondary axis, opening plane, or any combination thereof. The axis of rotation may be at an angle of about 120 degrees or less, about 110 degrees or less, or even about 95 degrees or less relative to the primary axis, secondary axis, opening plane, or any combination thereof. For example, the axis of rotation may be at an angle of about 85 degrees to about 95 degrees (e.g., about 90 degrees) relative to the primary axis and secondary axis.

The entry opening has a cross-sectional area. The cross-sectional area may be sufficiently large to comfortably accommodate an animal entering and exiting the chamber while maintaining litter and waste within the chamber. The cross-sectional area may be the cross-sectional area of the profile shape of the entry opening. The cross-sectional area may be measured along one or more planes parallel to the opening plane, primary axis, secondary axis, or a combination thereof. The cross-sectional area of the entry opening may be about 300 cm² or greater, about 500 cm² or greater, about 700 cm² or greater, about 900 cm² or greater, about 1.100 cm² or greater, or even about 1.200 cm² or greater. The cross-sectional area of the entry opening may be about 5.000 cm² or less about 4.000 cm² or less, about 3,000 cm² or less, about 2.000 cm² or less, or even about 1.500 cm² or less. The height of the entry opening along a primary axis may be about 20 cm or greater, about 25 cm or greater, about 30 cm or greater, or even about 40 cm or greater. The height of the entry opening along a primary axis may be about 75 cm or less, about 60 cm or less, about 55 cm or less, or even about 50 cm or less. The height and width of the entry opening may be defined by an inner surface of a chamber, bezel, or both at the entry opening. The entry opening may include an entry lip.

The litter device may include a bezel. The bezel may function to define the entry opening, provide an aesthetic appearance of a front of the litter device, maintain litter within the chamber, seal off any joints along the front of the device from litter, seal off any pinch points at and/or around the entry opening, house one or more sensors, house one or more control panels, house one or more user interfaces, the like, or any combination thereof. The bezel may have any shape, size, and/or form such the bezel may be able to provide a barrier for litter and/or other waste remnants while not interfering with entry and egress of an animal from the chamber. The bezel may have any size and/or shape for defining and/or encircling an entry opening. The bezel may have a shape reciprocal, similar, and/or same as the entry opening. The bezel may have a substantially circular and/or oval cross-sectional shape with an opening therein. The opening may define part of the entry opening and have similar and/or same dimensions as suitable for the entry opening. The bezel may have a shape and size so as to conceal one or more rims, edges, or both of a bonnet, base frame, chamber, or a combination thereof. The bezel may have a shape and size so as to conceal the space between a chamber and bonnet, chamber and base frame, or both. The bezel may be formed as a single piece or multiple pieces. The bezel may include an inner bezel, outer bezel, or both. The outer bezel may function to provide an aesthetically appealing bezel about the entry opening, conceal one or more components affixed to the inner bezel, or both. The inner bezel may function to retain one or more electrical components, affix the bezel to a bonnet, base, or both. The inner bezel and outer bezel may cooperate together to define a gap therebetween. The gap within the bezel may house one or more sensors, electrical components, control panels or components thereof, or any combination thereof. The inner bezel may be permanently and/or removably affixed to a bonnet, base frame, outer bezel, or a combination thereof. The inner bezel, outer bezel, or both may be affixed to the outer bezel, inner bezel, bonnet, base frame, or a combination thereof by one or more fasteners. The one or more fasteners may include one or more threaded fasteners (e.g., screw, bolt, nut), interlocking tabs, rivets, pins, the like, or a combination thereof. The inner bezel may be affixed to both the base frame and the bonnet. The inner bezel may be affixed along cut-outs of the base frame and bonnet which define an entry opening. The outer bezel may then be affixed to the inner bezel. The bezel may be comprised of one or more materials suitable for exposure to litter, waste, moisture, fumes, and the like. Examples of materials that can be used are rubber, plastic, metal, ceramic, or a combination thereof. The bezel may be made of the same or a different material as the bonnet, base frame, or both. The inner bezel, outer bezel, or both may include one or more mounts extending therefrom and into the gap of the bezel, toward the opposing bezel, into an interior of a bezel, to an exterior of the bezel, or a combination thereof. One or more mounts may include one or more sensor mounts, control mounts, or both. One or more sensor mounts may include one or more sensor boards. One or more sensor mounts may retain one or more sensors. One or more sensor mounts may be located within an interior, exterior, or both of the bezel. One or more control mounts may house and/or retain one or more control panels and/or user interfaces. One or more control mounts may be located within an interior, exterior, or both of the bezel.

The chamber includes one or more waste openings. The one or more waste openings may function to allow waste, used litter, or both to transfer from the chamber into the base, waste bin, or both. The waste opening may be at any location in the chamber so that the waste, used litter, or both may transfer from the chamber into a waste bin. The waste opening may be at any location in the chamber that aligns with the waste bin during a cleaning cycle, off-set from the waste bin while in a home position, or both. The waste opening may be formed as an aperture in an upper chamber, lower chamber, or both. For example, the waste opening may be formed as an aperture in the upper chamber such that it resides substantially opposite the waste bin while the chamber is in a home position. The waste opening may have any shape suitable for allowing waste to quickly transfer from the chamber to the waste drawer during a cleaning cycle. The waste opening may have a cross-sectional shape which is substantially circular, ovular, square, rectangular, trapezoidal, triangular, rhombus, the like, or any combination thereof. The waste opening may have a shape which is reciprocal with a cross-sectional shape of the waste bin. The waste opening may be located partially or completely on one side of a longitudinal plane of the device. The longitudinal plane may intersect the rotational axis, vertical plane, horizontal plane, or a combination thereof. The rotational axis, vertical plane, or both may be parallel to, lie within, or both to the longitudinal plane. The horizontal plane may be substantially perpendicular to the longitudinal plane. The longitudinal plane may divide the litter device into side halves. The side halves may each comprise a portion of the bonnet, chamber, and base. The side halves may be substantially symmetrical and/or mirrored about the longitudinal plane. Substantially symmetrical may still allow for certain features to be only located on one side of the device, such as a waste opening. A center of the waste opening may be offset from the longitudinal axis by an angle. A center of the waste opening may be angled from the longitudinal plane by about 0° or more, about 5° or more, about 10° or more, about 15° or more, or even about 20° or more. A center of the waste opening may be angled from the longitudinal plane by about 45° or less, about 35° or less, about 30° or less, or even about 25° or less. The angle may be measured when a chamber is in a home position. The waste opening may be located on one or more sides of a track. The waste opening may be located between an entry opening and a track. The waste opening while the chamber is in a home position, may not overlap with the waste bin. The waste opening, during a cleaning cycle, may substantially align, overlap, or both with a waste bin. The waste opening, during a cleaning cycle, may be rotated about the rotational axis. The waste opening, during a cleaning cycle, may rotate from a home position to an emptying position, a home position, any position therebetween, or a combination thereof. The emptying position may be when the chamber is rotated such that the waste opening is located adjacent to, overlapping with, substantially centered with, or a combination thereof the waste bin. The waste opening, during a cleaning cycle, may rotate by an angle of about 130° or greater, about 145° or greater, about 150° or greater, about 155° or greater, or even about 160° or greater to an emptying position. The waste opening, during a cleaning cycle, may rotate by an angle of about 230° or less, about 220° or less, about 200° or less, or even about 180° or less to an emptying position. The waste opening may rotate a complete revolution (e.g., 360°) from the start of a cleaning cycle to the end of a cleaning cycle. Rotation of the waste opening may occur when a track is rotated. Rotation of a track may rotate the chamber and the waste opening.

The chamber may include a rotation device. The rotation device may function to rotate the chamber, septum, screen, or a combination thereof about a rotational axis, during a cleaning cycle, or any combination thereof. The rotation device may be one or more tracks, gears, high friction surfaces, raised areas, toothed areas, contact surface areas, the like, or a combination thereof. The rotation device may be affixed to, integral with, in rotational communication with, or a combination thereof the chamber. The rotation device may be located on an exterior, interior, or both of the chamber. The rotation device include one or more belts, cogs, sprockets, toothed assemblies, rollers, wheels, the like, or a combination thereof. The rotation device may be manually rotated (e.g., without requiring a power source), automatically rotated (e.g., requiring a power source), or both. The rotation device may be driven by one or more drive mechanisms. The chamber may include a track about at least a portion of an exterior of the chamber. The base may include one or more drive mechanisms in rotational communication with and which drives the rotation device.

The chamber may include a track. The track may function to rotate the chamber about a rotational axis, cooperate with a drive source, or both. The track may have any suitable configuration for cooperating with and being driven by a drive source. The track may include or be a gear, toothed, or both. A gear may be a spur gear, helical gear, internal gear, the like, or a combination thereof. For example, the track may be a spur gear with teeth evenly spaced and projected about the perimeter. The track may be located about at least a portion of a periphery of the chamber. The track may be located about a portion of an upper chamber, lower chamber, or both. The track may encircle an outside wall of the chamber. The track may be located anywhere along an exterior of the chamber. The track may lay in and/or form a plane referred to as a track plane. The track plane may form an angle relative to the opening plane, vertical plane, horizontal plane, or a combination thereof. The track plane may be substantially parallel to the opening plane. The track plane may be substantially normal to an axis of rotation. The track plane may be at an angle relative to the vertical plane substantially similar as the opening plane. The track plane may form an angle with the vertical plane of about 5 degrees or more, about 10 degrees or more, or about 15 degrees or more, about 18 degrees or more, or even about 20 degrees or more. The track plane may form an angle with the vertical plane of about 60 degrees or less, about 50 degrees or less, about 45 degrees or less, about 30 degrees or less, or even about 25 degrees or less. For example, the track plane may form an angle with the vertical plane of about 5 degrees to about 50 degrees. As another example, the track plane may form an angle with the vertical plane of about 10 degrees to about 30 degrees. The track may be fairly concentric, off-set, or both relative to a center, great circle, lesser circle, or a combination thereof of the chamber. The track may be offset from the great circle of the chamber. A great circle may be defined as the circle which acts as an equator of the chamber, is located about the widest diameter of the chamber, is substantially parallel to an entry opening of a chamber, or a combination thereof. A great circle may be perpendicular to or be the joint between the upper chamber and lower chamber. The track may be offset from the great circle of the chamber. The track may be closer to an entry opening, front, rear, or a combination thereof of the chamber. The track may be distanced from the entry opening. The track may be located generally opposite the entry opening. The track may be distanced from the entry opening by about 45% or greater, about 60% or greater, about 70% or greater, about 75% or greater, or even about 80% or greater of a total length of a chamber. The track may be distanced from the entry opening by about 95% or less, about 93% or less, about 90% or less, about 87% or less, or even by about 85% or less of a total length of a chamber. The length of the chamber may be measured from the entry opening toward the rear, along a rotational axis, or both. The track may be used to rotate the chamber about the axis of rotation during a cleaning cycle. The track may be used to rotate the chamber clockwise, counterclockwise, or both. The track may be concealed by the bonnet, base, or both. Concealing the track may avoid creating pinch points or unnecessary contact points for one or more animals, humans, or both.

The litter device may include a bonnet. The bonnet may function to cover a track, cover a waste opening, provide an aesthetically appealing exterior, protect against one or more pinch points or contact points with one or more moving components, prevent contaminants (e.g., liquid, dust, fur, etc.) from entering into the device (e.g., such as between the track and drive source), or a combination thereof. The bonnet may partially or fully cover a track, waste opening, or both while the chamber is in home position, during a cleaning cycle, in an emptying position, or any combination thereof. The bonnet may be static, mobile, or both relative to the chamber when the chamber rotates. The bonnet being static relative to the chamber may allow for the bonnet to continuously cover the track, waste opening, pinch points, or a combination thereof while the chamber is in motion. The bonnet being static relative to the chamber may provide case in manufacturing, reliability during use, or both. The bonnet may have any suitable shape and/or size for covering and/or concealing a track, waste opening, or both; being located over and/or about at least a portion of a chamber; or any combination thereof. The bonnet may have a shape substantially reciprocal with the contour of a chamber, upper chamber, lower chamber, or a combination thereof. For example, the bonnet may have a shape which is substantially hemispherical. The bonnet may be substantially solid, continuous, have one or more openings, discontinuous, the like, or any combination thereof. The bonnet may be free of or include one or more openings. The one or more openings may align with a waste opening while the chamber is in a home position. The one or more openings may include a transparent covering. The transparent covering may allow for light to pass through while still physically covering a waste opening. The one or more openings may allow natural light into the chamber interior. The bonnet may be affixed to a base, bezel, litter dispenser, or a combination thereof. The bonnet may be permanently and/or removably affixed to a base, base frame, bezel, litter dispenser, or a combination thereof. The bonnet may be pivotably engaged with the base, base frame, or a combination thereof. The bonnet may be affixed to the base and/or base frame by one or more hinges, fasteners, or both. One or more fasteners may include one or more threaded fasteners (e.g., screw, bolt, nut), interlocking tabs, rivets, pins, the like, or a combination thereof. The bonnet may be affixed to the base and/or base frame by one or more hinges opposite an entry opening. The bonnet may be affixed to the base and/or base frame by one or more interlocking tabs where the bonnet mates with the base and/or base frame. The bonnet may be affixed to the bezel with one or more interlocking tabs where the bonnet mates with the bezel about the entry opening. The bonnet may be attached by one or more conductive fasteners to the bezel, base, base frame, or a combination thereof. One or more conductive fasteners may conduct current from the bezel, base, base frame, or a combination thereof to the bonnet. The flow of current via one or more conductive fasteners may indicate the bonnet is affixed to the base, base frame, and/or bezel. The stop of current flow via the one or more conductive fasteners may indicate the bonnet has been removed from the base, base frame, and/or bezel. One or more cleaning cycles may be prevented from occurring, the chamber may be prevented from rotating, or both when the bonnet is removed from the base, base frame, and/or bezel. The bonnet may include one or more interlock sensors as described in U.S. Pat. No. 8,757,094 and US Patent Application Publication No: 2013/0333625, incorporated herein by reference.

The litter device may eliminate waste during one or more cleaning cycles. A cleaning cycle may function to transfer waste from a chamber to a waste bin, waste drawer, base, the like, or any combination thereof. The cleaning cycle may function to rotate the chamber about a rotational axis. During a cleaning cycle, the chamber may rotate clockwise, counterclockwise, or both. A direction of rotation may be dependent on orientation of a septum, screen, or both.

The litter device includes a base. The base may function to support a chamber, house a waste drawer, house one or more electrical components, or any combination thereof. The base may have any size and shape so that the base may support the chamber, house a waste drawer, and/or house one or more electrical components. The base may rotatably support the chamber. The base may allow the chamber to rotate during one or more cleaning cycles. The base may be configured to rest on a surface. A surface may be any suitable surface for having a litter device resting thereon. The surface may be a floor, table, platform, substantially planar surface, or any combination thereof. The base may include one or more base frames, waste drawers, drawer cavities, chamber supports, steps, electrical components, ports, filters, lifts, slide devices, the like, or any combination thereof.

The base may include a base frame. The base frame may have any size and/or shape to support a chamber; mate with a bonnet; house a waste drawer, one or more electrical components, one or more filters and/or filter systems; rest on a surface; the like, or a combination thereof. The base frame may have a three-dimensional shape which is substantially spherical, ovoidal, cylindrical, hemispherical, cuboidal, conical, pyramidical, the like, or any combination thereof. For example, the base frame may have a first shape which is substantially cuboidal and/or cylindrical which extends to a second shape which is hemispherical. The base frame may have a shape which is substantially reciprocal to the shape of a waste drawer, chamber, or both. For example, the first shape which is substantially cuboidal and/or cylindrical may house the waste drawer while the second shape may be hemispherical and house a lower chamber. The second shape may include a cut-out. The cut-out may have a shape reciprocal with that of a chamber, entry opening, bezel, or both. The cut-out may be located on a same side of the device as the entry opening. The cut-out may be substantially U-shaped. The base frame may be affixed to a bezel at an open-end, along a cut-out, or both.

The base frame may include a bottom. The bottom may be a closed end of the base frame. The bottom may be opposite an open end, chamber support, or both of the base frame. The bottom may function to allow the base frame to rest on a surface. The bottom may function as a platform of a lift, may be integral with a platform of a lift, may be affixed to a platform of a lift, may support a lift, or any combination thereof. The bottom may have one or more features for adapting to uneven surfaces. The bottom may be substantially planar, flat, reside in one plane, or a combination thereof. The bottom may include one or more ridges, feet, or both. The one or more feet may be adjustable so that the litter device may rest level on a surface.

Adjacent to the bottom there may be a drawer cavity. The drawer cavity may function to house a waste drawer. The drawer cavity may be formed as a hollow interior in the base frame. The hollow interior may be reciprocal to, larger than, or both a waste drawer. The drawer cavity may include a waste drawer track, slide device, or both. A waste drawer track, slide device, or both may provide a track for the waste drawer to slide along when cither opening or closing, maintain alignment of the waste drawer, guide installation of a waste drawer into the drawer cavity, or any combination thereof. A waste bin, lift, or both may reside within the drawer cavity.

The base frame may include a drawer opening. The drawer opening may be formed as an opening in the base frame. The drawer opening may be located on a same or different side as an entry opening, hinge, or a combination thereof. The drawer opening may have a cross-sectional shape substantially reciprocal to the cross-sectional shape of a waste drawer. The drawer cavity may be defined as the space between the bottom of the base frame and a chamber support.

The base frame may be in fluid communication with a filter system. The base frame may include one or more port openings. One or more port openings may be located on a rear side, opposite a waste drawer front, opposite a waste drawer opening, opposite an entry opening, or a combination thereof. The one or more port openings may be closed by one or more port caps.

The chamber support may provide support for the chamber, a seal between the chamber and the waste cavity, an opening between the waste opening of the chamber and the waste bin, separation of one or more electrical components and the waste drawer, support for a drive mechanism, or any combination thereof. The chamber support may rest between a first shape and a second shape of the base frame. The chamber support may have a shape substantially reciprocal with a portion of a chamber. The chamber support may function as an isolated mount, such as described in U.S. Pat. No. 8,757,094 and US Patent Application Publication No. 2013/0333625, incorporated herein by reference.

The litter device includes a waste drawer. The waste drawer may function to collect waste, temporarily store waste, prevent malodors related to waste from exiting the device, or any combination thereof. The waste drawer may have any shape and size that allows the waste drawer to collect and temporarily store waste. The waste drawer may be located within a base, within a drawer cavity, between a chamber support and a bottom of a base, between a bottom of a base and the chamber, adjacent to a chamber, or any combination thereof. The waste drawer may be any size and/or shape such that it is able to temporarily collect and store waste. The waste drawer, or portions thereof, may have a three-dimensional shape which is substantially spherical, ovoidal, cylindrical, cuboidal, conical, pyramidical, the like, or any combination thereof. For example, a waste drawer may have a shape which is substantially cuboidal and hollow. The waste drawer may slide within a plane. The plane may be parallel or offset relative to a horizontal plane. The waste drawer may include a waste bin, drawer front, step, handle, or any combination thereof. The waste drawer may be removably located within the base. The waste drawer may be manually and/or automatically removable from the base. Manual may mean manual pulling of a drawer or a bias device driving the drawer open. Automatic may mean upon receiving an electric signal. The waste drawer may be at least partially located within a waste drawer cavity. A waste drawer may be opened via a pre-loaded spring, a gear system, track system, slide device, and/or the like. By providing an aid for opening the drawer, the physical effort to open the drawer may be reduced. A drawer front may form all or a portion of a forward-facing surface (e.g., same side as an entry opening) of the base. A drawer front may align with an exterior of a base frame so as to conceal the drawer cavity. A drawer front may have a cross-sectional shape substantially reciprocal with a cross-sectional shape of a drawer opening in the base frame. A reciprocal shape may allow for the drawer cavity by the drawer front to be completely sealed when the waste drawer is located within the drawer cavity. The drawer front may be affixed, integral with, or both to a waste bin. The drawer front may be forward-facing relative to the waste bin. The waste drawer may have a bottom. The bottom of the waste drawer may be affixed to a lift, integral with a lift, or both. The bottom of the waste drawer may be affixed to a platform of a lift, may be integral with a platform of a lift, may be the platform of a lift, or any combination thereof. The waste drawer may have one or more side walls. One or more side walls, a bottom of the waste drawer, or both may be affixed to one or more slide devices, waste drawer tracks, or any combination thereof.

The waste drawer may have a fixed or expandable volume. The expandable volume may allow for a waste drawer to expand in size and accommodate additional waste, allow for a litter device to be emptied less frequently, or both. The volume of the waste drawer may be increased and/or decreased manually and/or automatically. The waste drawer may include one or more telescoping segments, accordion segments, and the like. The telescoping and/or accordion segments may be formed in a bottom, side walls, a rear wall (e.g., opposite a drawer front), and/or a drawer front. The waste drawer may be expanded upon actuation of a motor, release of a pre-loaded spring, manual pulling, the like, or a combination thereof. The waste drawer may expand outward toward a rear, front, and/or side of the base. The base may include one or more additional drawer openings configured to allow the expanded waste drawer to exit. For example, a drawer opening may be located in a rear wall of the base frame which allows the waste drawer to expand outside of it. A waste level sensed by one or more waste level sensors may initiate expansion of a waste drawer.

The waste drawer may include one or more waste levelers. A waste leveler may function to move a waste drawer and level waste within the drawer. Leveling waste may allow for waste to be more uniformly spread within the waste drawer as opposed to having a higher height directly below the waste opening. Motion of the waste drawer may be a vibration, back and forth movement, side to side movement, tilting, the like, or any combination thereof. A waste leveler may be initiated after a cleaning cycle, after expansion of a drawer, after a certain level of waste is detected by one or more waste level sensors, the like, or any combination thereof. The one or more waste levelers may include a vibration isolation platform located under the waste drawer or be integrated into the waste drawer. The bottom of the waste drawer may function as a vibration isolation platform. One or more waste levelers may be separate from or share components with one or more lifts. For example, a platform of a lift may also be a platform of a waste leveler.

The waste drawer may include a waste bin configured to retain used litter, waste, a waste bag, or any combination thereof. The waste bin may have a hollow interior. The hollow interior may define a volume of the waste bin. The volume of the waste bin may be suitable for retaining multiple days of waste, used litter, or both. The volume of the waste bin may be suitable for storing waste which accumulates over 1 day or more, 3 days or more, 5 days or more, or even 7 days or more. The volume of the waste bin may be suitable for storing waste which accumulates over 20 days or less, 15 days or less, 12 days or less, or even 10 days or less. The volume of the waste bin may be about 7,500 cm³ or more, about 10,000 cm³ or more, about 12,000 cm³ or more, or even about 12,500 cm³ or more. The volume of the waste bin may be about 50,000 cm³ or less, about 40,000 cm³ or less, about 30,000 cm³ or less, about 20,000 cm³ or less, or even about 15,000 cm³ or less. The waste bin may include one or more seals. The one or more seals may allow for malodors to be retained with the drawer cavity, prevented from escaping outside of the litter device, or both. For example, the waste bin may include a rubber gasket about a periphery of an opening. The opening of the waste bin may be in fluid communication and/or alignment with an opening of a chamber support, may come into fluid communication and/or alignment with a waste opening, or a combination thereof. The opening of the waste bin may be in fluid communication with one or more filtering systems. The waste bin may be affixed to one or more steps and/or handles of the waste drawer.

The waste drawer may include a waste bag sealer. A waste bag scaler may function to close a waste bag prior to removal from the waste drawer. Closing may avoid malodors from the waste exiting the bag and entering into the ambient environment. Closing may occur prior the waste drawer being opened, after the waste drawer is opened, while the waste drawer is opening, or any combination thereof. Closing may be automatic or manual. Closing may provide a permanent seal, a temporary seal, or both. A permanent seal may only be opened by creating a new opening (e.g., cutting). A temporary seal may be able to be undone. A waste bag sealer may include a heated jaw sealer, heat sealing iron, quick bag seal closer, heat crimper, electric impulse sealer, heat roller, automatic twister, the like, or any combination thereof. Examples of concepts suitable for implementation into a litter device may include those provided by United States Plastic Corp. for sealing bags, incorporated herein in their entirety for all purposes. The waste scaler may be located within the base, waste drawer, or both. The waste scaler may be located near and/or at a top (e.g., rim) of a waste drawer.

The litter device may include one or more steps. The one or more steps may allow an animal to comfortably enter and exit the chamber via an opening. The one or more steps may have any size and shape that allows one or more animals to enter and exit the chamber via the opening. The one or more steps may be located on a same side of the device as an opening. The one or more steps may be part of the base, chamber, waste drawer, the like, or any combination thereof. The step may have any shape, size, and/or configuration to case entry and exit of an animal into the chamber, provide a handle for opening a waste drawer, cleaning excess litter from paws of an animal, or any combination thereof. The one or more steps may have a cross-sectional shape which is substantially circular, ovular, square, rectangular, trapezoidal, triangular, rhombus, the like, or any combination thereof. For example, a step may have a cross-sectional shape which is generally trapezoidal with rounded vertices. The cross-sectional shape may refer to a cross-section which is substantially parallel to a horizontal plane. One or more steps may extend outward, away, or both from a waste bin, drawer front, base frame, or a combination thereof. One or more steps may be permanently affixed to, removably affixed to, integral with, or both the waste bin, drawer front, base frame, or a combination thereof. One or more steps may be removable and/or affixed such that the one or more steps can be removed to dispose of litter and remnants collected in a hollow interior. The step may function as a handle. The step may include an indentation, groove, smaller thickness, or the like to provide a handle. The indentation, groove, or smaller thickness may be located opposite an upper surface which is used for the animal to step thereon. The upper surface, interior, or both may include a cleaning device. The step may be at least partially hollow. A hollow interior may allow for loose litter from a cleaning device to be collected.

The one or more steps may include a cleaning device. The cleaning device may function to remove litter remaining on feet (e.g., paws) of an animal when they exit the chamber, before completely leaving the litter device, or both. By removing litter from an animal's paws the cleaning devices prevents litter and other unwanted remnants from an animal's paws being tracked throughout a region surrounding the litter device. The cleaning device may have any configuration which removes litter from an animal's paws, can be located on a step, is unobtrusive, or any combination thereof. A cleaning device may have a cross-sectional shape similar to that of the step. A cleaning device may have a shape reciprocal with at least a portion of an interior hollow portion of a step. A similar shape allows for the cleaning device to completely cover an upper surface of a step, be located within the step, or both. The one or more cleaning devices may have one or more surfaces which are contoured. Contoured may mean ribbed, grated, corrugated, slotted, the like, or any combination thereof. For example, a surface opposing the step may be corrugated and/or ribbed. A contoured surface may be beneficial in loosening litter, waste, and/or other debris from the paw of an animal; collecting the litter, waste, and/or other debris; or any combination thereof. For example, the peaks of a contoured surface may come in contact with the paws of an animal and aid in removal of the litter, waste, and/or other debris. For example, the valleys of the contoured surface may collect the litter, waste, and/or other debris. The one or more cleaning devices may include or be free of one or more openings. One or more openings may allow for litter to pass through, pass from the cleaning device into a hollow interior of a step, pass into an interior of the cleaning device, or a combination thereof. The one or more cleaning devices may include a mat, pad, screen, insert, the like, or a combination thereof. The one or more cleaning devices may be made of any material which can remove the litter, other unwanted remnants, or both; is able to withstand exposure to litter and animal waste; or a combination thereof. The cleaning device may be comprised of rubber, plastic, polymer, natural material, synthetic material, or a combination thereof. The cleaning device may be made from a same or different material as the remainder of the litter device. The cleaning device may be removable from a step. By being removable, the hollow interior can be exposed, such as for removing collected litter and remnants. The cleaning device may be secured via one or more fasteners or may be free of being secured with one or more fasteners. One or more fasteners may include one or more threaded fasteners (e.g., screw, bolt, nut), interlocking tabs, rivets, pins, the like, or a combination thereof. To avoid being attached by one or more fasteners, the cleaning device may rest atop a rim and/or flange of a step, within one or more supporting surfaces projecting from an inside of a step, or both. By avoiding the use of fasteners, removing the cleaning device may be quick and simple for a user.

The litter device may include a septum. The septum may function to sort waste from litter, separate used litter from unused litter, or both. The septum may have any size or shape suitable for being located within the chamber to sift through litter during a cleaning cycle. The septum may be a single piece or a plurality of pieces. The septum may include a screen portion, septum portion, hinge, or a combination thereof. The septum may be located within the chamber, affixed to an interior of the chamber (e.g., upper chamber), integral with the chamber, or any combination thereof. The septum may be located substantially across from a lower chamber, liner, or both. The septum may be aligned with a waste opening, partially through a waste opening, or both of the upper chamber. The septum portion may include a septum opening. The septum opening may be aligned, co-axial, centered, and/or even reside within a waste opening. The septum opening may be formed in a protrusion of a septum portion. A protrusion may create a funnel to guide waste through the waste opening into the waste drawer. The septum opening may be the hollow portion of the protrusion. The protrusion may be referred to as a neck. The protrusion (e.g., neck) may be located within the waste opening. The septum portion may be statically affixed to an interior of the chamber, such as the upper chamber. Thus, the septum portion may rotate with and remain fixed to the chamber during rotation. The septum may include a hinge. The hinge may connect a septum portion to a screen portion. The hinge may allow a septum portion, screen portion, or both the ability to move relative to the other during one or more cleaning cycles, rotation of a chamber, or both. The hinge may be affixed to, integral with, adjacent to, located between, or a combination thereof to the septum portion and screen portion. The hinge may be a multi-component hinge (e.g., butt hinge) or a single component hinge. A single component hinge may be a living hinge. The hinge may be made of any material which allows movement of the screen portion, septum portion, or both relative to the other. Movement may be during the forming process of the septum, before and/or during installation of the septum into the chamber, rotation of the chamber during a cleaning cycle, or any combination thereof. The hinge may also be formed such that it allows the screen geometry to be formed in the line of draw of the septum for molding. The hinge may be made of the same material as the screen portion, septum portion, or both. The hinge may allow for the screen portion to be angled relative to the septum portion. The hinge may allow for the septum to be installed and contour to a shape substantially reciprocal to an interior of the chamber. The hinge may impart flexibility to the screen portion relative to the septum portion. The screen portion, in a home position of the chamber, natural resting portion of the septum outside of the chamber, or both may be at an acute, perpendicular, or obtuse angle relative to the septum portion. The screen portion may be at an angle relative to the septum portion of about 90 degrees or greater, about 120 degrees or greater, about 140 degrees or greater, or even about 150 degrees or greater. The screen portion may be at an angle relative to the septum portion of about 180 degrees or less, about 170 degrees or less, or even about 160 degrees or less. The angle may be measured as the angle between the surfaces facing toward the litter bed, lower chamber, base, interior of the chamber, or any combination thereof. The screen portion may be free of attachment to the chamber. The screen portion may only be affixed to the chamber via the septum portion. The screen portion may move (e.g., swing) and/or remain substantially static relative to the hinge, septum portion, or both during a cleaning cycle, rotation of the chamber, or both. The screen portion may include one or more openings, such as a plurality of openings. The screen portion may be ribbed, grated, corrugated, slotted, meshed, the like, or any combination thereof. The plurality of openings may be sized such as to allow for unused (e.g., clean) litter to pass therethrough while waste, used litter, clumps, lumps, and/or the like are prevented from passing through. The plurality of openings in the screen portion may allow for litter to be sifted through during a cleaning cycle so as to separate waste from the unused litter. The septum may be comprised of a suitable material. The material may be non-stick; liquid impenetrable; resistant to damage, penetration, scent absorption, stain, or a combination thereof by litter, waste, liquids, solids, semi-solids, or a combination thereof. The septum material may be rubber, polymeric material, a synthetic material, a natural material, or any or a combination thereof. The septum may be made of the same material or differing materials. For example, the living hinge, septum portion, and screen portion may be comprised of the same one or more materials.

The litter device may include one or more seals. One or more seals may function to prevent odor from transferring from a base, waste drawer, or both to the chamber, about the chamber, an exterior of the litter device, or any combination thereof. The one or more seals may include any seals capable of forming a scaling a junction between two or more surfaces to prevent malodors, liquid, waste, and/or litter from passing therethrough. The one or more seals may include one or more mechanical seals. The one or more mechanical seals may include one or more adhesives, sealants, gaskets, compressing fittings, plugs, the like, or any combination thereof. One or more gaskets may include one or more flange gaskets, O-ring gaskets, brush seals, the like, or any combination thereof. The one or more seals may be located between one or more mating surfaces, at a junction of two or more surfaces, or both. The one or more seals may be part of the chamber, base, litter dispenser, ventilation system, the like, or any combination thereof. The one or more seals may be located between mating surfaces of a waste drawer and base. The one or more seals may be located between a mating surface of a waste bin and a chamber support. The one or more mating surfaces may be about a perimeter of the waste bin, opening of the chamber support, or both where the waste bin contacts the chamber support. One or more seals may be located between a chamber and a base. One or more seals may seal a gap between a chamber and a chamber support. One or more seals may be located between a base frame and a waste drawer. One or more seals may be located where a waste drawer mates with a drawer opening. One or more seals may be located about a perimeter of the drawer opening, a reciprocal portion of the waste drawer, or both. One or more seals may still allow movement for one or more components while preventing leakage while in a static position. The one or more seals may allow for the waste drawer to be removed from a base, chamber to rotate, or both. The one or more seals may be comprised of one or more seal materials. One or more seal materials may include rubber, silicone, metal, paper, cork, felt, neoprene, nitrile rubber, fiberglass, polytetrafluoroethylene (PTFE), plastic polymers such as polychlorotrifluoroethylene, the like, or a combination thereof.

The litter device may include one or more drive mechanisms. One or more drive mechanisms may function to rotate a chamber, septum, and/or screen; drive a track; drive one or more gears; drive one or more lift mechanisms (e.g., raise and/or lower); produce movement of a cleaning cycle; or any combination thereof. One or more drive mechanisms may be any suitable mechanism for rotating and/or engaging with a chamber, track, septum, screen, or combination thereof. One or more drive mechanisms may be any suitable mechanism for raising, lowering, and/or otherwise moving one or more lift mechanisms. One or more drive mechanisms may be engaged, in rotational communication, or both with the track. One or more drive mechanisms may be engaged with a lift mechanism. One or more drive mechanisms may include one or more cogs, pulleys, sprockets, gears, belts, direct drives, motors, drive shafts, cranks, manual aids, the like, or any combination thereof.

The drive mechanism may include a drive source. The drive source may convert electrical energy into mechanical energy. The drive source may transfer mechanical energy. The drive source may be configured to be in electrical and/or mechanical communication with a power source. A power source may be an outlet, direct current, alternating current, a human individual, the like, or a combination thereof. A drive source may be a motor or other power supply. The drive source may be an electronic motor, pneumatic power supply, hydraulic power supply, another power supply, or a combination thereof. The drive source may be configured to be manual and free of requiring a power source. The drive source may utilize one or more manual aids. The drive source may include a hand crank. The hand crank may be in rotatable communication with a drive shaft. The drive source may transfer or produce torque in a drive shaft.

The drive source may include a drive shaft. The drive shaft may receive torque from the drive source, output torque, or both. The drive shaft may be in communication with the drive source. The drive shaft may be rotationally affixed to or in communication with the drive source. The drive source, drive shaft, or both may be in rotational communication with one or more gears. A drive shaft may include one or more gears integrated thereto. For example, an end of a drive shaft may have teeth integrated therein. The teeth may go about a circumference of the drive shaft at an end. The teeth may engage with one or more gears. As an alternative, a drive shaft may otherwise be affixed to one or more gears. The drive source, drive shaft, or both may transfer torque and/or drive one or more gears. The one or more gears may be configured to engage and/or mate with a track, one or more other gears, or both.

The one or more gears may transfer torque, drive, or both to a track. The one or more gears may include one or more pinion gears (e.g., circular), linear gears (e.g., rack), spur gears, bevel gears (e.g., straight, spiral), helical gears, internal gears, worm gears, stepped gears, the like, or a combination thereof. One or more gears may be engaged with one or more other gears. One or more gears may include a drive gear, one or more intermediate gears, or both. A drive gear may be the first gear to receive torque from a drive shaft, the drive source, or both. A drive gear may be part of or separate from a drive shaft. A drive gear may be integrally formed and/or in rotational communication with a drive source. A drive gear may be directly or indirectly engaged with one or more intermediate gears, a track, or both. One or more gears may function to change a direction of torque, transfer rotation, or both. For example, a pair of bevel gears may work together to change a direction of torque received from a hand crank. One or more gears may function to maintain a direction of torque, transfer rotation, or both.

One or more drive mechanisms may be comprised of materials which are resistant to moisture, vapor, fumes, and the like. Examples of materials that can be used are rubber, plastic, metal, ceramic, or a combination thereof. One or more drive mechanisms may be partially or completely located within a base, base frame, chamber support, or a combination thereof. One or more drive mechanisms may be physically separated from the drawer cavity such that litter and waste are prevented from coming into contact with the drive mechanism. One or more drive mechanisms may reside in a pocket within the chamber support. The drive mechanism may reside in the chamber support on a side opposite of the waste drawer, a same side as the chamber, or both. The chamber support may be an isolated mount. A drive mechanism may be affixed to the base. A drive mechanism may be affixed to an exterior wall of the base. A drive mechanism may extend outwardly from the base. For example, a hand crank may be movably affixed to the base and extend outward.

The litter device may include one or more controllers. The one or more controllers may function to receive one or more signals, transmit one or more signals, control operations of one or more components of the litter device, or a combination thereof. The one or more controllers may be in communication with one or more sensors, drive mechanisms, control panels, user interfaces, the like, or any combination thereof. The one or more controllers may be adapted to receive, transmit, or both one or more signals from the one or more sensors, drive mechanisms, control panels, user interfaces, the like, or a combination thereof. The one or more controllers may reside within or be in communication with the litter device. The one or more controllers may be located within or affixed to a base, chamber, bezel, or a combination thereof. The one or more controllers may include one or more controllers, microcontrollers, microprocessors, processors, storage mediums, or a combination thereof. One or more suitable controllers may include one or more controllers, microprocessors, or both as described in U.S. Pat. Nos. 8,757,094 and 9,433,185 and US Patent Publication No. 2019/0364840 incorporated herein in their entirety for all purposes.

The litter device may include a lift. The lift may function to raise and/or lower the height of the litter device, provide a more ergonomic position for emptying waste from a litter device, lessen the reach to refill the litter device with clean litter, or any combination thereof. The lift may be static or moveable. The lift may be located below the litter device, base, below a waste drawer, between a portion of the base and the waste drawer, or any combination thereof. The lift may be integrated as part of the base, as part of the waste drawer, or both. The lift may have the litter device supported thereon. The base may rest on the lift. The lift may be manually and/or automatically operated. Manually may mean being raised and/or lowered by a foot pump, hand pump, crank, a preloaded mechanical spring, the like, or any combination thereof. Automatically may mean being raised and/or lowered via a power source. The lift may share and/or have a separate power source as one or more other components (e.g., drive mechanism) of the litter device. The lift may share some components with and/or have a separate drive mechanism as compared to one or more other components of the litter device. The lift may include a hydraulic lift, pneumatic lift, electric lift, self-leveling lift, manual lift, or any combination thereof. For example, the lift may include and/or resemble a manual lift table, a powered (e.g., electric) lift table, a self-leveling scissor table, ground level scissor table, hydraulic scissor table, pneumatic scissor table, mechanical scissor table, vertical ram platform lift, the like, or a combination thereof. The lift may include one or more base supports, movement aids, legs, platforms, the like, or a combination thereof.

The lift may include one or more base supports. The one or more base support may function as the foundation of the lift. The base support may function to support and/or retain one or more movement aids, legs, platforms, the litter device, a waste drawer, or any combination thereof. The base support may have any size and/or shape suitable for retaining the litter device and/or waste drawer. The base support may have one or more channels integrated therein. One or more channels may receive one or more legs, components of one or more legs, or any combination thereof. The one or more channels may be located within an interior, exterior, or both of the base support. For example, the base support may include one or more channels which receive one or more guide rollers, one or more guide rollers being associated with each leg. The channels and guide rollers together may allow for one or more legs to move inward and outward within the channel. The base support may include or be free of one or more wheels. One or more wheels may be affixed to the bottom of the base support, opposite of legs. One or more wheels may allow for the lift, and overall litter device, to be easily moved. The one or more wheels may have one or more wheel locks. One or more wheel locks may allow for wheels to be locked in place and prevent rolling of the wheels.

The lift may include one or more movement aids. One or more movement aids may function to raise and/or lower a platform, extend and/or compress one or more legs, act as one or more legs, or any combination thereof. One or more movement aids may be any type of mechanism capable of raising/lower the platform, driving movement of one or more legs, or both. One or more movement aids may be affixed to a base support, one or more legs, a platform, or any combination thereof. One or more movement aids may be located between the base support and platform. One or more movement aids may be located within the platform, within the legs, or a combination of both. One or more movement aids may include one or more pistons, cylinders, biasing devices, the like, or a combination thereof. One or more biasing devices may include one or more springs. One or more cylinders may include 1 or more cylinders to 4 or less cylinders. The one or more cylinders may be filled with hydraulic fluid, compressed air (e.g., pneumatic pump), and/or the like. The one or more cylinders may be attached to the one or more base supports, legs, or both. The one or more cylinders may receive and cooperate with one or more pistons. The one or more pistons may extend from and/or retract into the cylinder. Movement of the piston may depend on pressure within the cylinder, a power source providing input into the cylinder, or both. Extension of one or more pistons from one or more cylinders may result in one or more legs constricting and extending. Retracting of one or more pistons into one or more cylinders may result in one or more legs expanding and lowering.

The lift may include one or more legs. One or more legs may function to lower and/or raise the platform, cooperate with one or more movement aids, or both. One or more legs may extend between the base support and the platform. One or more legs may be directly and/or indirectly affixed to the base support, platform, one or more movement aids, or a combination thereof. One or more legs may have one or more ends statically and/or moveably affixed to a platform, base support, or both. One or more legs may include one or more guide rollers integrated therein. One or more guide rollers may be located at one or more ends of one or more legs. One or more guide rollers may be moveably engaged within one or more channels. The one or more guide rollers may include one or more bearings, wheels, rollers, the like, or any combination thereof. One or more legs may have one or more movement aids attached. One or more legs may be one or more movement aids. For example, in a scissor lift design, the one or more legs may have one or more cylinders and pistons attached thereto. As another example, in a vertical ram platform lift design, the one or more legs may be the one or more cylinders and pistons. The one or more legs may be in the form of a pantograph and/or crisscross pattern, substantially vertical, or both. The one or more legs may include one or more hinge points to allow for constructing and extending of the one or more legs.

The lift may include one or more platforms. The one or more platforms may function to support a litter device, support a base and/or waste drawer, as part of the base, as part of a waste drawer, or any combination thereof. The one or more platforms may be separate from a base, waste drawer, or both. For example, the bottom surface of the base, waste drawer, or both may rest on and/or be affixed to the platform. The one or more platforms may be a portion of a base and/or waste drawer. For example, a bottom surface of the base, the waste drawer, or both may be the platform. The platform may have one or more channels integrated therein. One or more channels may receive one or more legs, components of one or more legs, or any combination thereof. The one or more channels may be located within an interior, exterior, or both of the platform. For example, the platform may include one or more channels which receive one or more guide rollers, one or more guide rollers being associated with each leg. The one or more channels may be formed on a bottom of the platform, opposite the base and/or waste drawer, or both. The one or more channels may be formed on one or more sides of the platform, opposing one another. The channels and guide rollers together may allow for one or more legs to move inward and outward within the channel.

The lift may include one or more slide devices. One or more slide devices may allow a lift to move from a closed position to an open position. The closed position may mean the lift is stored within a portion of the litter device. The closed position may mean the lift is stored within an interior of the litter device, base, a waste cavity, or both. The open position may mean that the lift is removed from an interior of the litter device, base, waste cavity, or any combination thereof. The one or more slides may be affixed to a base support, a platform, or both of the lift. The one or more slides may be affixed to a waste cavity, the base, the waste drawer, or any combination thereof. For example, one or more slides may be bottom or side mounted to a base support of a lift and reciprocally mounted within the waste cavity along interior walls of the base. The one or more slide devices may be bottom mounted, side mounted, undermounted, center mounted, the like, or any combination thereof. The one or more slide devices may be one or more roller slides, ball-bearing slides, or both. The one or more slide devices may function similar to, and/or resemble, one or more drawer slides. The one or more slide devices may be telescoping. Telescoping may allow the one or more slide devices to extend to an open position, retract into a closed position, or both. The one or more slide devices may include one or more rollers, ball-bearings, the like, or a combination thereof. The one or more slide devices may include one or more lift members, intermediate members, base members, or any combination thereof. For example, one or more roller slides may only have a lift member and a base member to enable telescopic motion. As another example, one or more ball-bearing slides may have a lift member, intermediate member, and base member to enable telescopic motion. The lift member, intermediate member, base member, or a combination thereof may each have one or more rollers, ball-bearings, or any combination thereof. The lift member, intermediate member, base member, or a combination thereof may each have one or more grooves formed therein. A roller of one member may fit within a groove of another member. For example, in a roller slide, the lift member and base member each have a groove and one or more rollers. The one or more rollers of the lift member fit and are disposed within the groove of the base member, and the one or more rollers of the base member fit and are disposed within the groove of the lift member. As another example, in a ball-bearing slide, the lift member is affixed to a portion of the lift, such as the base; the base member is affixed to a portion of the base, such as an interior wall which forms the drawer cavity; and the intermediate member interfaces with both the base member and the lift member with two or more sets of ball-bearings. A first set of ball-bearings affixed to the intermediate member may be disposed within and moveable along one or more grooves of the lift member. A second set of ball-bearings affixed to the intermediate member may be disposed within and moveable along one or more grooves of the base member. The one or more slides may be manually and/or automatically extended and/or retracted.

The lift may include one or more storage units. A storage unit may include space for storing accessories related to operating a litter device, owning a domestic animal, or both. A storage unit may be formed as one or more drawers. A storage unit may include one or more steps. The steps may allow for an animal to step up to a raised position of the litter device. The steps may be formed as part of a drawer and/or handle adapted to open the storage unit.

The litter device may include one or more user interfaces. The one or more user interfaces may function to display information related to a litter device, receive user inputs related to the litter device, transmit information related to the litter device, or any combination thereof. The one or more user interfaces may be part of the bezel, chamber, bonnet, base, the like, or any combination thereof. The one or more user interfaces may be at least partially housed within the bezel. The one or more interfaces may be partially located on and/or be an exterior surface of the bezel. One or more user interfaces may include one or more graphic user interfaces, user inputs devices, speakers, microphones, the like, or any combination thereof. One or more user interfaces may be part of one or more computing devices. One or more user interfaces may include one or more interfaces capable of relaying information (e.g., data entries) to a user, receiving information (e.g., data signals) from a user, or both

The one or more user interfaces may include one or more graphic user interfaces. The one or more graphic interfaces may include one or more screens. The one or more screens may be a screen located directly on the litter device, another computing device, or both. The one or more screens may be a screen on a mobile computing device, non-mobile computing device, or both. The one or more graphic interfaces may be located and/or affixed to the bezel, bonnet, base, chamber, the like, or any combination thereof. The one or more graphic interfaces may include and/or be in communication with one or more user input devices. The one or more user input devices may allow for receiving one or more inputs (e.g., instruction signals) from a user. The one or more input devices may include one or more buttons, wheels, keyboards, switches, touchscreens, the like, or any combination thereof. The one or more user input devices may include features for further understanding of their functionality. The one or more features may include colors, braille, associated sounds via one or more speakers, the like, or any combination thereof. The one or more input devices may be integrated with a graphic interface. The one or more input devices may include one or more touch-sensitive monitor screens. The one or more screens may include LCD, LED, OLED, EPD, PDP, the like, or any combination thereof. The one or more graphic user interfaces may be in direct and/or indirect communication (e.g., electrical communication) with one or more controllers, speakers, microphones, other user interfaces (e.g., mobile device), the like, or a combination thereof.

The litter device may include one or more speakers. The one or more speakers may provide audio feedback of one or more processes, notifications, and the like of the litter device. The one or more speakers may be located in any part of the litter device suitable for housing a speaker. The one or more speakers may be located and/or affixed to the bezel, bonnet, base, chamber, the like, or any combination thereof. For example, the one or more speakers may be located within the bezel. The one or more speakers may be in direct and/or indirect communication with one or more user interfaces, control panels, controllers, microphones, the like, or any combination thereof. The one or more speakers may audibly project information relayed from and/or received by one or more user interfaces. The one or more speakers may provide a means for a user to communicate with the litter device if they are unable to read, sec, or understand writing on a graphic user interface.

The litter device may include one or more microphones. The one or more microphones may function to receive audio from one or more individuals. The one or more microphones may cooperate with one or more speakers, sensors (e.g., image sensor), graphic user interfaces, controllers, the like, or any combination thereof. The one or more microphones may be located in any part of the litter device suitable for housing a microphone. One or more microphones may be located and/or affixed to the bezel, bonnet, base, chamber, the like, or a combination thereof. A microphone dedicated to receiving vocal commands from an individual may be located on an exterior of the litter device. The one or more microphones may transmit information to one or more controllers. The one or more microphones may be particularly useful in allowing a user to communicate with the litter device and avoid button selections, such as an individual with limited eyesight.

The automated litter device may include one or more sensors. The one or more sensors may function to detect one or more conditions of the device. The one or more sensors may be located in any one or more portions of the litter device which may allow for a sensor to detect the presence and/or absence of one or more conditions of the one or more components. One or more sensors may be located adjacent to an entry opening, in proximity and/or affixed to a drive source, near one or more pinch points, part of a bonnet, part of a bezel, part of base, within or affixed to the chamber, or any combination thereof. One or more sensors may be located within or on a bezel. One or more sensors may be located on an upper portion of the bezel. One or more sensors may be located adjacent to an entry opening, opposite the base, a same side of a chamber as a waste opening, an opposite side of a chamber as a waste opening, same side of a chamber as an upper chamber, a bottom of a base, or any combination thereof. For example, one or more sensors may be located on a sensor board within a bezel. The angle of the opening plane relative to a vertical plane may result in one or more sensors being located over the litter, having a line of sight into the litter, over a hollow interior of the chamber, having a line of sight into a hollow interior, over the waste drawer opening, having a line of sight into the waste drawer (e.g., via the waste opening), or any combination thereof. One or more sensors may be located on or near one or more legs and/or feet of a base. For example, the one or more legs and/or feet of a base may include one or more mass and/or weight sensors, on the one or more conditions sensed, one or more sensors may transit one or more signals to one or more controllers, processors, communication modules, computing devices, or any combination thereof. The one or more sensors may be a single sensor or a plurality of sensors. One or more sensors may include 1 or more, 2 or more, or even 3 or more sensors. One or more sensors may include 15 or less, 12 or less, 10 or less, 9 or less, 8 or less, 7 or less, or even 5 or less sensors.

One or more sensors may be adapted to detect one or more conditions related to: a mass, change in mass, or both of the litter device; a presence of litter, the amount of litter, or both; a presence of waste, a level of waste, or both; the presence of light, light above, at, and/or below a lumen level, or a combination thereof; a connection between two or more components of the device (e.g., support base and bonnet); the presence of one or more pinch conditions; one or more positions of a chamber; an operating condition of a motor; presence of an animal within one or more portions of the litter device; or any combination thereof. One or more sensors may be adapted to sense the presence of an animal within a chamber, the presence of waste within a waste bin in a base, a level of litter in a chamber, a position of the chamber relative to the base, or any combination thereof. One or more sensors may be adapted to sense the presence of an animal within the litter device and within a portion other than the chamber. One or more sensors may be able to sense presence, measure distance, measure a displacement, detection a position relative to one or more components of the automated litter device, or any combination thereof.

One or more sensors may include one or more mass sensors, capacitive sensors, infrared sensors, laser sensors, ultrasonic sensors, membrane sensors, radio frequency (RF) admittance sensors, conductive sensors, optical interface sensors, microwave sensors, the like, or combination thereof. One or more laser sensors may include one or more time-of-flight sensors. One or more laser sensors may include one or more cone laser sensors. One or more cone laser sensors may include one or more wide cone laser sensors, narrow cone laser sensors, or both. The one or more sensors may include one or more waste sensors (e.g., indicator), presence sensors, light sensors, interlock sensors, pinch detectors, position sensors, motor sensors (e.g., one or more laser sensors, distance sensors,) or any combination thereof. One or more sensors may provide the function of multiple sensors. For example, one or more waste sensors may also be one or more presence sensors. One or more exemplary sensors may be discussed in U.S. Pat. No. 8,757,094; US Patent Application Publication Nos. 2013/0333625 and 2019/0364840; and PCT Patent Application No.: PCT/US2020/029776 (published as PCT Publication No. WO 2020/219849A1), all of which are incorporated herein by reference in their entirety for all purposes.

### Cleaning Cycle

The litter device may complete one or more cleaning cycles. A cleaning cycle may function to transfer waste from within a chamber into a base, waste drawer, or combination thereof. A cleaning cycle may function to sort clean litter (e.g., unused litter) from waste, used litter, clumps, lumps, or any combination thereof. A cleaning cycle may be initiated after one or more presence sensors sense an animal has exited the chamber, waste has been deposited within the chamber, a user has initiated a cleaning cycle, or any combination thereof. A cleaning cycle may begin with rotation of a chamber. A chamber may be driven by a track, drive mechanism, or both. A chamber may be driven by a track affixed thereto. The track may be driven by a drive mechanism. The chamber may rotate clockwise, counterclockwise, or both. Rotation direction may be determined by the location of the septum, the screen portion relative to the septum portion, a waste opening, or a combination thereof. During a cleaning cycle, the chamber may rotate from a home position to an emptying position, from an emptying position to a home position, from an emptying position to a leveling position, from a home position to a leveling position, from a leveling position to a home position, or any combination thereof. For example, a cleaning cycle may comprise rotation of the chamber from a home position to an emptying position, from the emptying position to a leveling position, and from the leveling position back to the home position. Rotation from the emptying position to the leveling position may include passing the home position. The home position may be a resting position of the chamber suitable for an animal to use the litter device. The emptying position may allow for waste to transfer to a waste drawer. In the emptying position the waste opening may be aligned with the waste drawer. The leveling position may allow for litter to level itself along a bottom chamber, liner, or both before returning to a home position. During a cleaning cycle, the chamber may then rotate in a first direction from the leveling position back to a home position. Returning to the home position may allow for an animal to once again use the litter device. An exemplary cleaning cycle is disclosed in U.S. Pat. No. 8,757,094; US Patent Application Publication Nos. 2013/0333625 and 2019/0364840; and PCT Patent Application No.: PCT/US2020/029776 (published as PCT Publication No. WO 2020/219849A1), all of which are incorporated herein by reference in their entirety for all purposes.

### Filter System

The present teachings also relate to a filtering system. The filtering system may function to prevent, reduce, neutralize, and/or even eliminate odor from air passing therethrough from the litter device. The filtering system may have any size, shape, and/or configuration for reducing or even eliminating malodor associated with animal waste. The filtering system may be an active system, passive system, or both. An active system may be one that moves air to reduce or eliminate odor. A passive system may be one that absorbs malodor. The reduction of malodor may occur through eliminating bacteria causing the odor, filtering the odor, cooling the air to reduce the odor, or any combination thereof. The filtering system may include one or more air circulation devices, filters, light treatment devices, heat exchange devices, the like, or a combination thereof. One or more light treatment devices may be any energy source suitable for killing bacteria waste which causes a malodor. A suitable light treatment device may include one or more ultraviolet lights. One or more heat exchange devices may function to change an air temperature of air within a filtering system, such as reducing the air temperature. Cooling the air may suppress growth of bacteria associated with malodors. One or more heat exchange devices may include one or more thermoelectric devices (TED). One or more thermoelectric devices may include one or more Peltier devices. One or more filters may include one or more physical filters. One or more physical filters may be any filter suitable for absorbing malodor from air as the air passes through the filter. One or more physical filters may include zeolite, charcoal, nylon wool, synthetic wool, silica gel, baking powder, the like, or a combination thereof. The filtering system may be part of the litter device, affixed to the litter device, within the litter device, part of an exterior of the litter device, or any combination thereof. A filtering system may be located between a chamber and a base, adjacent to a base, within the base, part of the chamber, outside of the base, outside of the chamber, or any combination thereof. The filtering system may be affixed to the chamber, the base, or both. The filtering system may be located generally opposite a waste opening of a chamber, adjacent to a waste bin, opposite a waste drawer opening, outside of the base, adjacent to an exterior wall of a base frame, or any combination thereof. The filtering system may be free of, may include, be part of, or combination thereof a ventilation system. The filtering system may include one or more housings, physical filters, caps, ventilation systems, ducts, the like, or any combination thereof.

### Litter Dispenser

The present teachings further relate to a litter dispenser. A litter dispenser may function to store clean, unused litter; refill a litter device, a chamber, or both with clean and unused litter; extend the usability of a litter device without human intervention; or any combination thereof. The litter dispenser may have any size, shape, and/or configuration to be in fluid communication with an interior of a chamber; affixed to a litter device, base, bonnet, chamber, or any combination thereof; have the ability to transfer a portion of litter stored therein into a chamber; have the ability to store litter; or any combination thereof. The litter device may include, be affixed to, or be free of a litter dispenser. The litter dispenser may be located generally opposite an entry opening. By being opposite the entry opening, the litter dispenser may not interfere with entry and exit by an animal, functionality with a septum and/or liner, or a combination thereof. The litter dispenser may be particularly useful in extending the usability of a litter device without human intervention. For example, a waste drawer may have a waste storage capacity greater than the litter capacity in the chamber. Capacity may be measured in volume, usage frequency by an animal, or even days. As during a cleaning cycle, used litter is transferred into the waste drawer along with animal waste, over time the usable litter may be depleted, fall below a desired level, or both. If the usable litter level falls below a predetermined volume within the chamber, it may become too shallow. Too shallow of litter may cause an animal to not be interested in the litter box. Too shallow of litter may cause a higher portion of waste to come into direct contact with an interior surface of the chamber, liner, or both. Additionally, the usable litter in the chamber may be depleted before the waste drawer is full. Traditionally, a human would have to intervene and refill the chamber with fresh litter for continued use of the litter device by an animal. The litter dispenser may be particularly advantageous in reducing human intervention with the litter device and providing a consistent volume of litter within the chamber. The litter dispenser may automatically deliver clean, unused litter into the chamber. The litter dispenser may deliver litter into the chamber once the litter within the chamber reaches a certain quantity (e.g., volume, height, etc.). The level of litter within the chamber may be sensed by one or more sensors. For example, one or more presence sensors, waste sensors, or both may sense the quantity of litter within the chamber. The litter stored within the litter dispenser may be any kind of litter suitable for use with the litter device. The litter dispenser may include a hopper, lid, dispenser housing, dispensing device, the like, or any combination thereof. A suitable litter dispenser is disclosed in PCT Patent Application No.: PCT/US2020/029776 (published as PCT Publication No. WO 2020/219849A1), incorporated herein by reference in its entirety for all purposes.

### Illustrative Examples

Any of the features described herein may be combined or used in lieu of one or more features described in U.S. Pat. Nos. 8,757,094 and 9,433,185; US Patent Application Publication Nos. 2013/0333625 and 2019/0364840; and PCT Patent Application No.: PCT/US2020/029776 (published as PCT Publication No. WO 2020/219849A1) which are incorporated by reference herein in their entirety for all purposes.

Further, any features described in the examples herein may be combined with one another. For example, the user interface may be combined with the lift; the hand crank may be combined with the user interface; the user interface, sensors, hand crank, lift, and expandable waste drawer may be combined; and the like.

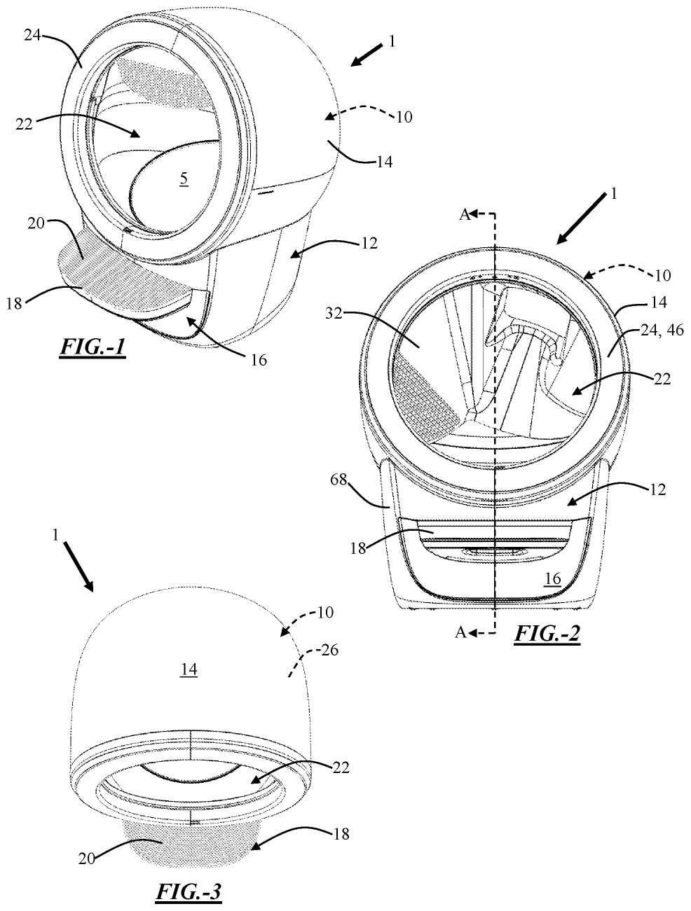

FIG. 1 illustrates a litter device 1. The device 1 includes a chamber 10 and a base 12. Located within the chamber 10 is litter 5. The chamber 10 is supported by the base 12. The chamber 10 is rotatable relative to the base 12. The base 12 may comprise one or more components which assist in rotation of the chamber 10. The chamber 10 is at least partially covered by a bonnet 14. The bonnet 14 is attached to the base 12. The chamber 10 is also rotatable relative to the bonnet 14 (e.g., the bonnet 14 remains static while the chamber 10 rotates). The base 12 includes a waste drawer 16. Upon rotation of the chamber 10, waste within the chamber 10 may be transferred from within the chamber 10 to the waste drawer 16. The waste drawer 16 includes a step 18. The step 18 may include a cleaning device 20. The device 1 includes an opening 22. The opening 22 may allow for an animal to enter and exit the chamber 10. The animal may use the step 18 to facilitate entering and exiting the chamber 10. The device 1 also includes a bezel 24. The bezel 24 is located about the opening 22. The bezel 24 may be affixed to the bonnet 14 and the base 12. The bezel 24 may remain static while the chamber 10 rotates.

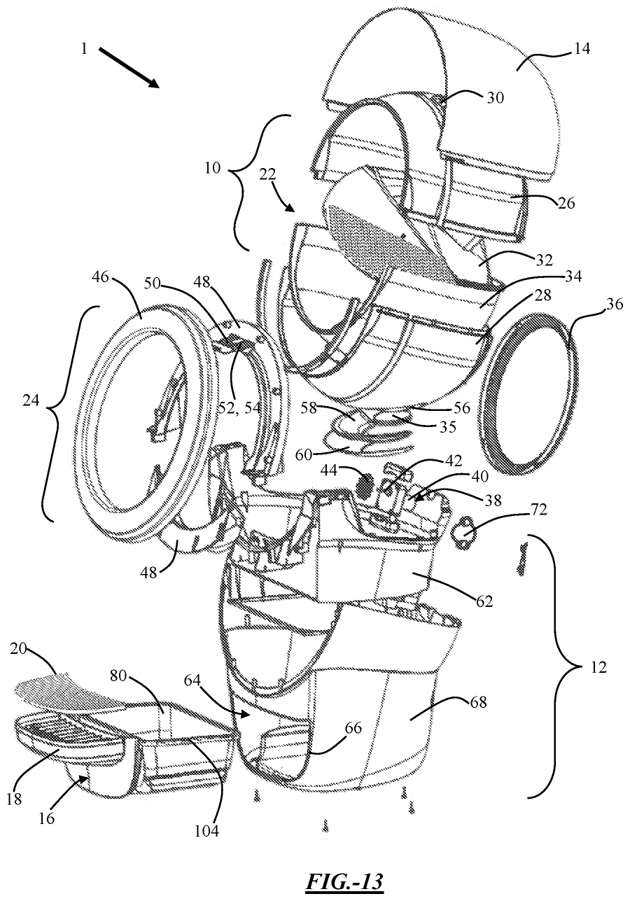

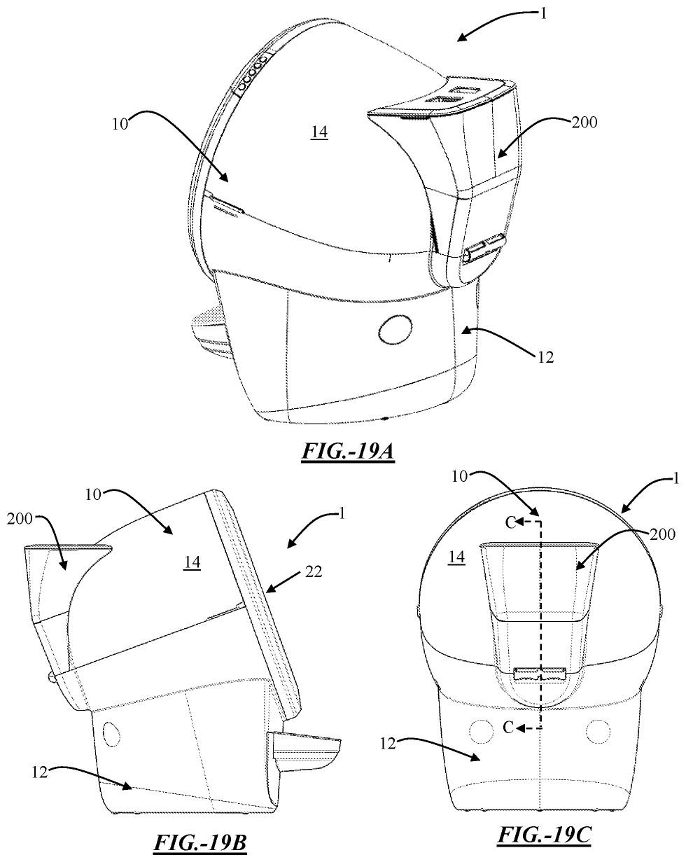

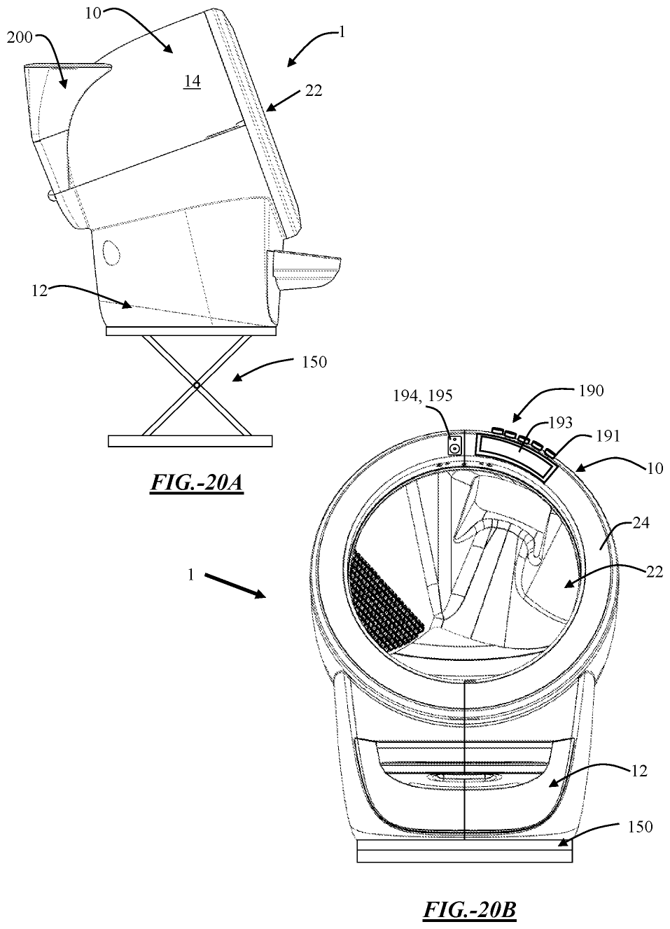

The device 1 may include a litter dispenser 200 (such as illustrated in FIG. 19A-20B). The litter dispenser 200 (not shown) may contain additional litter 5 separate from that located in the chamber 10. The litter dispenser 200 (not shown) may be in fluid communication with the chamber 10 such that litter 5 is able to transfer from the litter dispenser 200 to the chamber 10. The litter dispenser 200 (not shown) may be attached to the chamber 10, the base 12, or both. The litter dispenser 200 may release litter 5 into the chamber 10 upon one or more sensors 52 (not such as illustrated in FIGS. 12 and 13) detecting a certain level or less of litter 5 within the chamber 10. The litter dispenser 200 (not shown) may stop releasing or not release litter 5 into the chamber 10 upon one or more sensors 52 (not shown) detecting a certain level of litter 5 or greater within the chamber 10.

FIG. 2 illustrates a litter device 1. The device 1 includes a chamber 10. A bonnet 14 is located around a portion of the chamber 10. An opening 22 is formed in the chamber 10. Inside the chamber 10 is a septum 32. A bezel 24 is located about the opening 22. An outer bezel 46 is the portion of the bezel 24 visible from the exterior. The bezel 24 is affixed to the base 12. The base includes a base frame 68. Located within and removable from the base frame 68 is a waste drawer 16. The waste drawer 16 includes a step 18.

FIG. 3 illustrates a litter device 1. The litter device 1 includes a bonnet 14. A bonnet 14 covers an upper chamber 26. The upper chamber 26 is part of a chamber 10. The chamber includes an opening 22. The device 1 includes a step 18. The step 18 may allow for an animal to comfortably enter and exit from the chamber 10 via the opening 22. The step 18 includes a cleaning device 20.

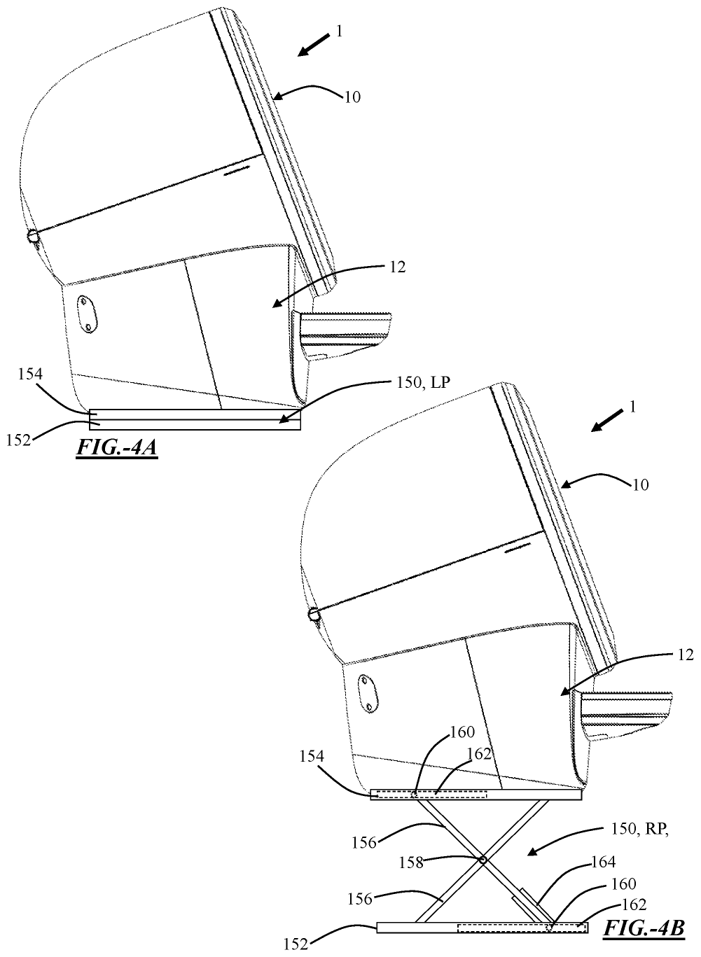

FIGS. 4A and 4B illustrate a litter device 1. The litter device 1 includes a chamber 10 supported by a base 12. The base 12 is supported by a lift 150. The lift 150 may be attached to or at least partially integrated into the base 12. FIG. 4A illustrates the lift 150 in a lowered position LP. The lowered position LP may also be a compressed position. FIG. 4B illustrates the lift 150 in a raised position RP. The raised position RP may also be an extended position. The lift 150 includes a base support 152 and a platform 154. In the lowered position LP, the lift 150 is compressed such that the platform 154 rests on or is in very close proximity to the base support 152. The lift 150 includes a plurality of legs 156. The legs 156 are connected with one another in a scissor configuration. The legs 156 are connected with one another via a pivot pin 158. The pivot pin 158 may be any suitable pivoting mechanism, such as a stud, bolt, shaft, pin, and/or the like. One or more legs 156 may include one or more guide rollers 160 at one or more ends. The base support 152, platform 154, or both may include one or more channels 162. The one or more guide rollers 160 are configured to rotate within the one or more channels to result in compression and/or extension of the plurality of legs 156. To drive extension and/or compression of the plurality of legs, the lift 150 includes a movement aid 164. The movement aid 164 may be in the form of a cylinder and piston. The lift 150 is shown as a scissor lift. It is also possible that the lift 150 be configured with as a vertical ram lift in which the legs are telescoping instead of a scissor configuration.

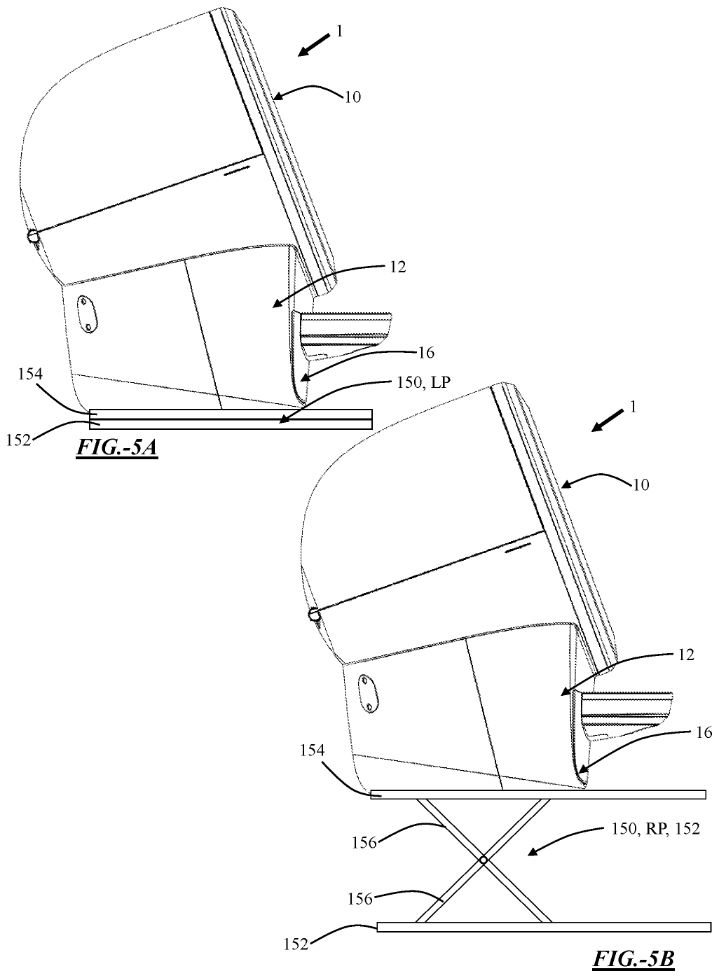

FIGS. 5A and 5B illustrate a litter device 1. The litter device 1 includes a chamber 10 supported by a base 12. The base 12 is supported by a lift 150. The lift 150 may be attached to or at least partially integrated into the base 12. FIG. 5A illustrates the lift 150 in a lowered position LP. The lowered position LP may also be a compressed position. FIG. 5B illustrates the lift 150 in a raised position RP. The raised position RP may also be an extended position. The lift 150 includes a base support 152, platform 154, and legs 156. The base support 152 and platform 154 extend beyond a front of the litter device 1. By extending beyond the front, the platform 154 may provide a support surface for the waste drawer 16 when opened.

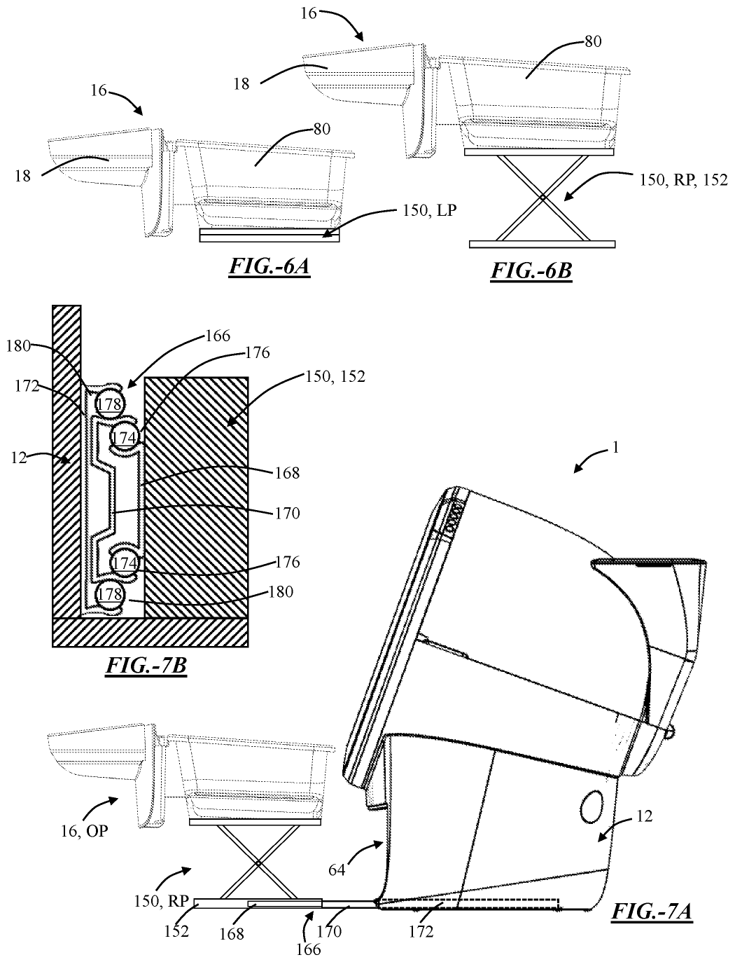

FIGS. 6A and 6B illustrate a waste drawer 16. The waste drawer 16 includes a step 18 and waste bin 80. The waste drawer is supported by a lift 150. The lift 150 may be attached to or at least partially integrated to the waste bin 80. FIG. 6A illustrates the lift 150 in a lowered position LP. FIG. 6B illustrates a lift 150 in a raised position RP.

FIG. 7A illustrates a litter device 1. The litter device 1 includes a base 12. The base 12 includes a drawer cavity 64. The drawer cavity 64 receives a waste drawer 16. The waste drawer 16 is shown in an open position OP. The waste drawer 16 is supported by a lift 150. The lift 150 is in a raised position RP. The lift 150 is affixed to the base 12 via one or more sliding devices 166. The sliding device 166 may have a telescoping arrangement. The telescoping arrangement of the sliding device 166 allows for the waste drawer 16 and lift 150 to be pulled out and pushed back into the drawer cavity 64. A sliding device 166 may be affixed to a base support 152 of the lift 150 and an interior wall of the drawer cavity 64. The sliding device 166 includes a lift member 168, intermediate member 170, and a base member 172.

FIG. 7B illustrates a cross-section of a sliding device 166. The sliding device 166 is shown as a ball-bearing slide. The sliding device 166 includes a lift member 168, intermediate member 170, and base member 172. The lift member 168 is affixed to the base support 152 of the lift 150. The lift member 168 is affixed to an interior wall of the base 12. The intermediate member 170 interfaces with both the lift member 168 and base member 172. A first set of ball bearings 174 is affixed to the intermediate member 170. The first set of ball bearings 174 is disposed within and moveable along a groove 176 of the lift member 168. A second set of ball bearings 178 is affixed to the intermediate member 170. The second set of ball bearings 178 is disposed within and moveable along a groove 180 of the base member 172.

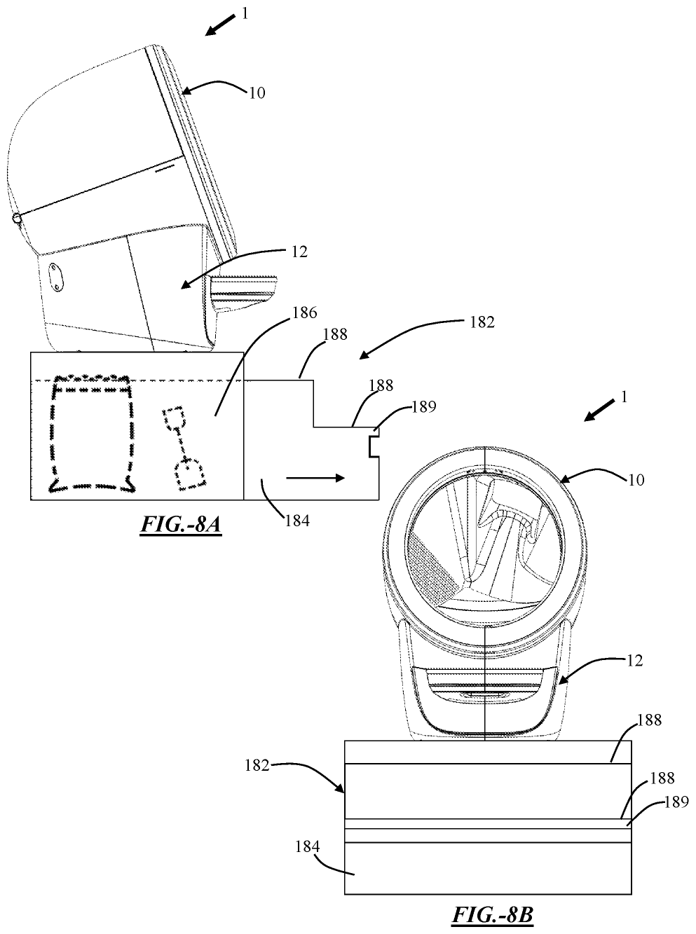

FIGS. 8A and 8B illustrate a litter device 1. The litter device 1 includes a chamber 10 supported by a base 12. The base 12 is located on a storage unit 182. The storage unit 182 includes a drawer 184. The drawer 184 is configured to retain accessories 186. The storage unit 182 includes steps 188. The steps 188 allow an animal to climb up and into the chamber 10. The steps 188 also provide a handle 189 such that a user is able to open the drawer 184.

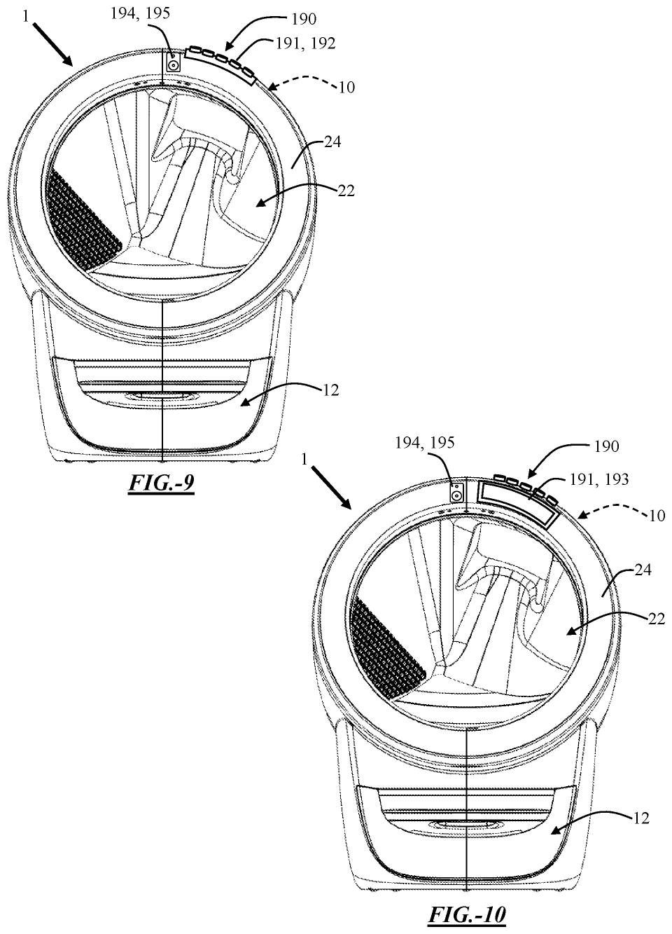

FIGS. 9 and 10 illustrate a litter device 1. The litter device 1 includes a chamber 10 supported by a base 12. The chamber 10 includes an opening 22. The opening 22 is surrounded by a bezel 24. The bezel 24 includes a user interface 190. In FIG. 6, the user interface 190 includes a plurality of user inputs 191. The user inputs 191 are a plurality of buttons 192. In FIG. 7, the user interface 190 includes a screen 193. The litter device 1 further includes a speaker 194 and microphone 195. The speaker 194 and microphone 195 are located on the bezel 24.

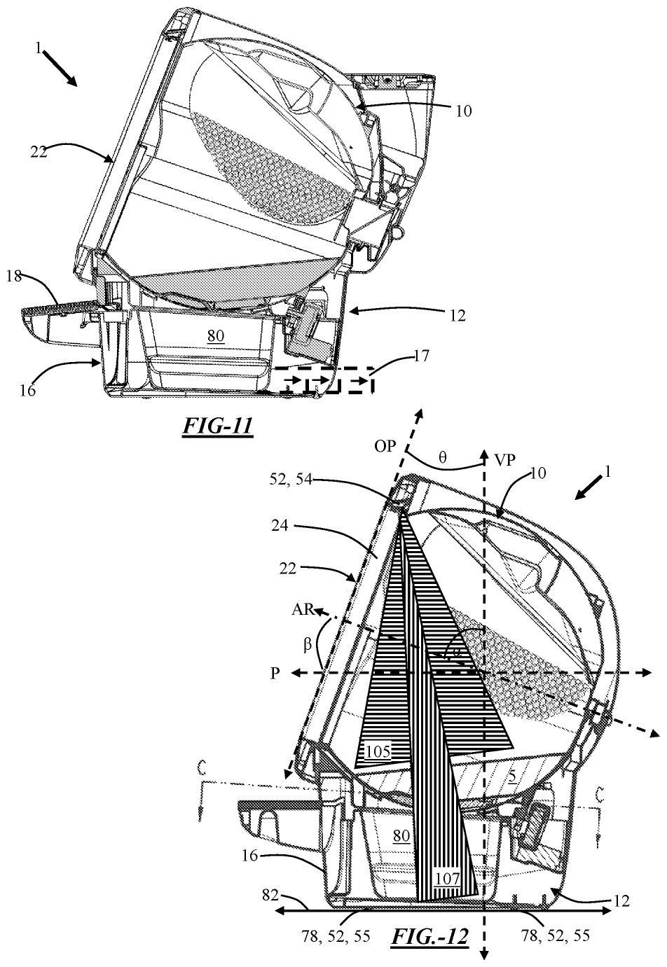

FIG. 11 illustrates an interior of a litter device 1. The device 1 includes a chamber 10 and a base 12. The chamber 10 is substantially spherical or globe-shaped. The chamber 10 includes an opening 22. Located below the chamber 10 is a waste drawer 16. The waste drawer 16 includes a step 18. The waste drawer 16 includes a waste bin 80. The waste drawer 16 is expandable. The waste drawer 16 includes an expandable rear 17. The expandable rear 17 may expand such as by telescoping. By being expandable, the volume of the waste bin 80 is able to be increased. The waste drawer 16 is able to expand toward a rear of the base 12. The waste drawer 16 may even be able to expand and project outside the base 12.

FIG. 17 illustrates a sensing range within an automatic litter device 1. The device 1 includes a chamber 10 supported by a base 12. The chamber 10 is tilted such that an axis of rotation AR is not parallel to a surface 82. The axis of rotation AR forms an angle α with vertical which is represented by a vertical plane VP. The axis of rotation AR forms an angle β with a plane P parallel to a surface 82. The opening 22 extends along an opening plane OP. The opening plane OP forms an angle Θ with the vertical plane VP. Due to the tilt of the chamber 10, one or more sensors 52 affixed to the bezel 24 at the opening 22 are able to sense one or more conditions within the device 1. Specifically, due to the tilt of the chamber 10, the one or more sensors 52 are aligned with the litter 5 and waste bin 80. The one or more sensors 52 may be one or more laser sensors, infrared sensors, time-of-flight sensors, the like, or a combination thereof. The one or more sensors may be one or more cone sensors 54. For example, two wide cone sensors and a one narrow cone sensor may be used together. The one or more sensors 52 may be able to measure a distance, level, amount, displacement, and/or even position of litter, waste, or both within the chamber 10, within the waste drawer 16, or both. For example, a level or amount of litter within the chamber may be determined by the distance measured from the one or more sensors 52 to an upper surface of the litter 5 within the chamber. One or more of the sensors 52 have an animal presence sensing range 105. The animal presence sensing range 105 covers a majority of an upper surface of the litter 5 within the chamber. One or more of the sensors 52 which provide the animal presence sensing range 105 are able to sense or detect the presence of an animal within the chamber 10. The one or more sensors 52 which provide the animal presence sensing range 105 may be one or more cone sensors, such as two wide cone sensors or even the combination of two wide cone sensors and one narrow cone sensor. The one or more sensors 52 have a waste level sensing range 107. The waste level sensing range 107 is able to cover a surface area within a waste bin 80 of a waste drawer 16. The one or more sensors 52 which provide the waste level sensing range 107 have the “line of sight” aligned with the waste bin 80 when the waste opening 30 is rotated during a cleaning cycle such that the waste opening 30 exposes the waste bin 80. This line of sight alignment is a result of the tilt of the chamber relative to the vertical axis. If the chamber were to have its axis aligned with the vertical axis, the sensors would have a sensing range looking across the opening as opposed to into the chamber or would have to be mounted at an angle looking inward. The one or more sensors 52 which provide the waste level sensing range 107 may include a single narrow cone sensor. In addition to sensing the presence of an animal within the chamber 10, waste or a waste level within the waste drawer 16, the one or more sensors 52 may also provide position sensing of the chamber 10 before, during, and/or after a cleaning cycle. It is also possible that one or more sensors 52 also include one or more mass sensors 55. The one or more mass sensors 55 may be part of one or more feet 78 of a base 12.

FIG. 13 is an exploded view of the litter device 1. A bonnet 14 may cover the chamber 10. The bonnet 14 may be pivotally engaged with the base 12, such as by one or more hinges 70 (not shown). The chamber 10 comprises an upper chamber 26 and a lower chamber 28. The bonnet 14 has a shape substantially reciprocal to that of the upper chamber 26. The bonnet 14 is also solid such that it covers a waste opening 30 formed in the upper chamber 26. Located inside the chamber 10 is a septum 32. Also located inside the chamber 10 is a liner 34. The liner 34 may be flexible. The liner 34 may include a weight 35. The weight 35 may reside within an indentation (not shown) of the liner 34. The lower chamber 28 includes a filter cavity 56. The filter cavity 56 houses a removable filter 58. The filter 58 is retained within the filter cavity 56 by a filter cap 60. Affixed to the exterior of the chamber 10 is a track 36. The track 36 is located opposite the opening 22 of the chamber 10. The track 36 is in the form of a ring gear having the gear teeth formed about a periphery. The track 36 is rotationally engaged with a drive source 38. The drive source 38 is a motor 40 with a drive shaft 42 rotationally engaged with a gear 44. The gear 44 meshes with the track 36 so that rotation from the drive source 38 is transferred to the track 36. The track 36 is statically affixed to the chamber 10. Thus, rotation of the track 36 results in rotation of the chamber 10. Located about the opening 22 is a bezel 24. The bezel 24 is affixed to the base 12. The bezel 24 includes an outer bezel 46 and inner bezel 48. The outer bezel 46 is affixed to and covers the inner bezel 48. The bezel 24 includes a sensor board 50. The sensor board 50 is mounted onto the inner bezel 48 and located between the outer bezel 46 and inner bezel 48. The sensor board 50 is mounted such that it is opposite the base 12, including the waste drawer 16. The sensor board 50 includes one or more sensors 52. The one or more sensors 52 may be one or more laser sensors. The one or more sensors 52 may be one or more cone sensors 54. The base 12 includes a chamber support 62 and base frame 68. The chamber support 62 rests within the base frame 68. The chamber support 62 houses the drive source 38. The chamber support 62 separates the waste drawer 16 from the chamber 10. The chamber support 62 aids in forming a drawer cavity 64. The waste drawer 16 resides within the drawer cavity 64. The waste drawer 16 is movable in and out of the drawer cavity 64 via a drawer opening 66 in the base 12. The waste drawer 16 includes a step 18. The step 18 may be able to be used as a handle. The step 18 includes a cleaning device 20. The waste drawer 16 includes a waste bin 80. The waste drawer 16 also includes a seal 104. The seal 104 may be located about a periphery of a waste bin 80. The periphery may be defined by a rim or flange. The base 12 may include one or more port caps 72. Although not illustrated, the litter device 1 may include a lift 150, user interface 190, litter dispenser 200, and drive source 38 as shown in FIGS. 4A-7B, FIGS. 9-10, and FIGS. 18A-18B.

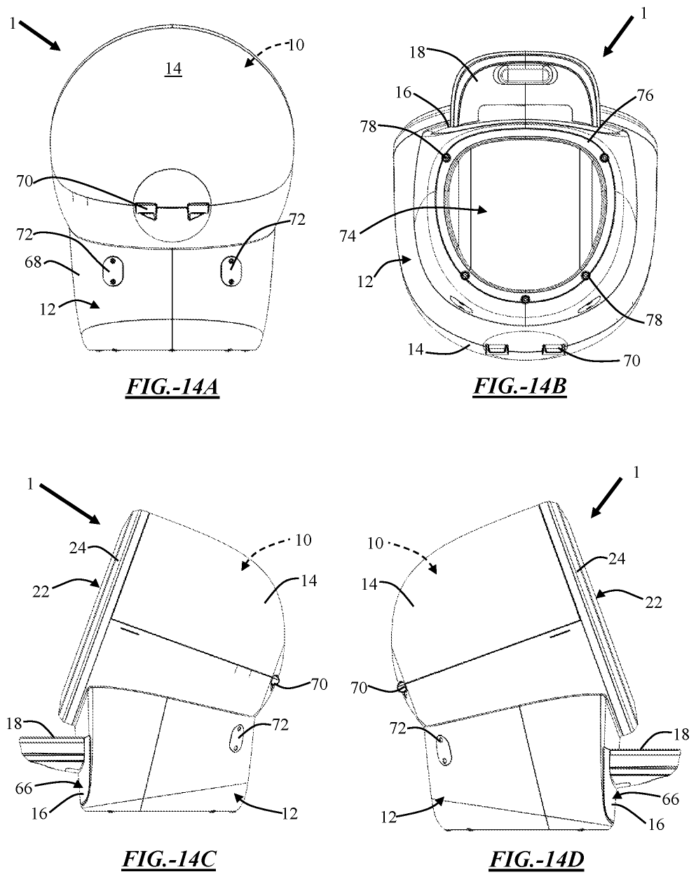

FIG. 14A illustrates a litter device 1. The device 1 includes a chamber 10 supported by a base 12. Covering the chamber 10 is a bonnet 14. The bonnet 14 is pivotally affixed to the base 12. The bonnet 14 is affixed to the base frame 68 via one or more hinges 70. The base frame 68 includes one or more port caps 72. The port caps 72 are located opposite a drawer opening 66 (not shown).

FIG. 14B illustrates a litter device 1. The device includes a base 12. Located within the base 12 is waste drawer 16. The waste drawer 16 includes a step 18. The base 12 is affixed to a bonnet 14 via one or more hinges 70. The bottom 74 of the base 12 includes a bottom ridge 76. The bottom ridge 76 may be useful for being the portion of the device 1 which rests on a surface, such as the floor. The bottom ridge 76 includes a plurality of feet 78. The feet 78 may include threaded shafts (not shown). The feet 78 may move relative to the bottom ridge 76. Movement of the feet 78 out of the ridge 76 may allow for balancing the device 1 on uneven surfaces, such a slope on a floor.

FIGS. 14C and 14D illustrate opposing sides of a litter device 1. The device 1 includes a chamber 10 supported by a base 12. A bonnet 14 covers a portion of the chamber 10, while another portion of the chamber 10 rests within the base 12. The bonnet 14 is affixed to the base 12. The bonnet 14 is pivotally engaged with the base 12 via one or more hinges 70. The one or more hinges 70 are located opposite an opening 22. Located about an opening 22 to the chamber 10 is a bezel 24. The bezel 24 is affixed to the base 12. The base includes a plurality of port caps 72. Opposite the port caps 72 is a drawer opening 66. Located within the drawer opening 66 is a waste drawer 16. The waste drawer 16 includes a step 18.

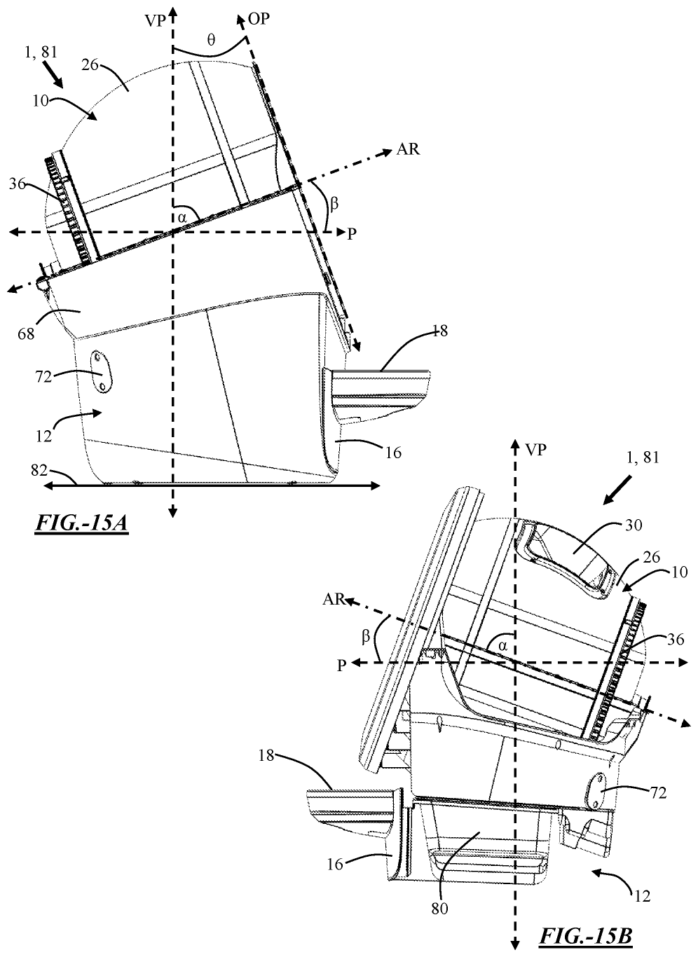

FIG. 15A illustrates a litter device 1 without a bonnet 14, while FIG. 15B also has the base frame 68 removed. The device 1 includes a chamber 10. While in a home position 81, an upper chamber 26 is located above the base 12. The base 12 includes one or more port caps 72. The base 12 also includes a waste drawer 16 with a step 18. The waste drawer 16 includes a waste bin 80. The waste bin 80 is located under the chamber 10. When the chamber 10 rotates during a cleaning cycle, the waste opening 30 is aligned with the waste bin 80 allowing waste to be transferred from chamber 10 to the waste drawer 16. A cleaning cycle results in rotation of the chamber 10. Rotation of the chamber 10 results from rotation of the track 36. The track 36 is statically affixed to the chamber 10 so that rotation of the track 36 results in rotation of the chamber 10. The chamber 10 rotates about an axis of rotation AR. The axis of rotation AR forms an angle α with vertical which is represented by a vertical plane VP. The axis of rotation AR forms an angle β with a plane P parallel to a surface 82. The surface 82 is one which the device 1 rests upon, such as a floor. The opening 22 extends along an opening plane OP. The opening plane OP forms an angle θ with the vertical plane VP.

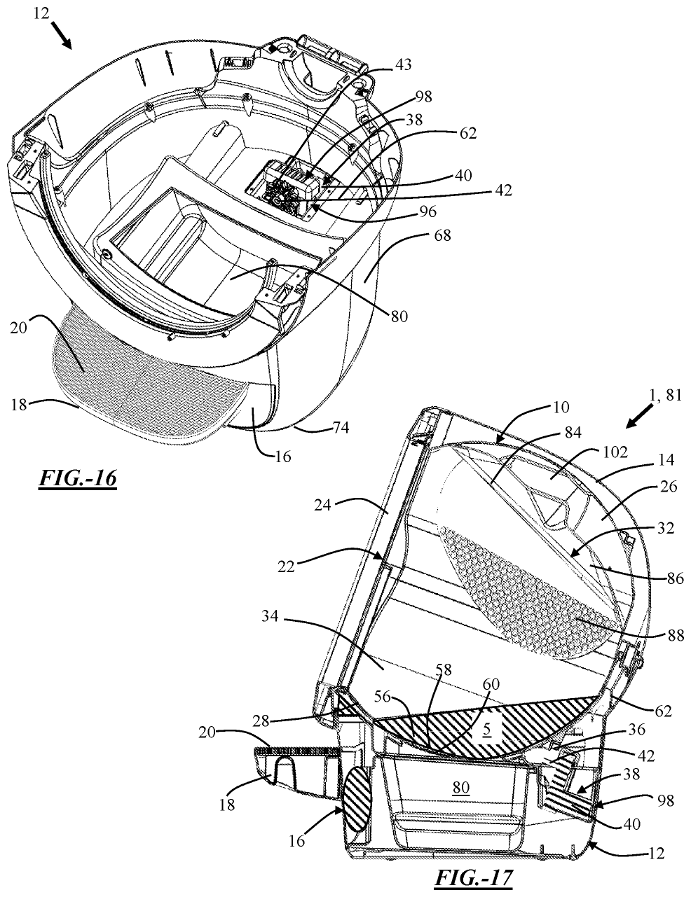

FIG. 16 illustrates a base 12. The base 12 includes a base frame 68. Located within the base frame 68 is a waste drawer 16. The waste drawer 16 includes a waste bin 80 located within the base frame 68. The waste bin 80 is located between a bottom 74 and a chamber support 62. The waste drawer 16 also includes a step 18. Located on the step 18 is a cleaning device 20. The chamber support 62 includes an opening 96. The opening 96 is open to the waste bin 80. The chamber support 62 also houses some of the electrical controls 98 of the device 1. The electrical controls 98 include the drive source 38. The drive source 38 includes a motor 40 and drive shaft 42. The drive shaft 42 is engaged with a gear 44, such as a pinion. The gear 44 meshes with and drives the track 36 (not shown).

FIG. 17 illustrates an interior of a litter device 1. The device 1 includes a chamber 10 and a base 12. The chamber 10 includes an upper chamber 26 attached to a lower chamber 28. The chamber 10 is substantially spherical or globe-shaped. The chamber 10 includes an opening 22. The opening 22 leads into the interior of the chamber. An animal can enter through the opening 22 to use litter 5 located within the chamber 10. Also, within the chamber is a liner 34. Opposite of the liner 34 is a septum 32. The septum 32 includes a septum portion 86 attached to a screen 88 via a living hinge 84. The septum 32 includes a neck 102 which forms a septum opening 100 (not shown). The septum opening 100 is aligned with the waste opening 30 (not shown) in the upper chamber 26. In the home position 81, the bonnet 14 covers the waste opening 30. During a cleaning cycle, the chamber 10 rotates such that the waste opening 30 aligns with the opening 96 (not shown) in the chamber support 62. The waste opening 30 also aligns with the waste bin 80, so that waste may pass from the waste opening 30 to the waste bin 80. The waste bin 80 is part of a waste drawer 16. The waste drawer 16 includes a step 18. The step includes a cleaning device 20 located therein. The waste drawer 16 is located within a base 12. The base 12 includes the chamber support 62. The chamber support 62 houses one or more electrical controls 98. The one or more electrical controls 98 include the drive source 38. The drive source 38 includes a motor 40 and drive shaft 42. The drive source 38 is in rotatable communication with the track 36 to result in rotation of the chamber 10 during a cleaning cycle.

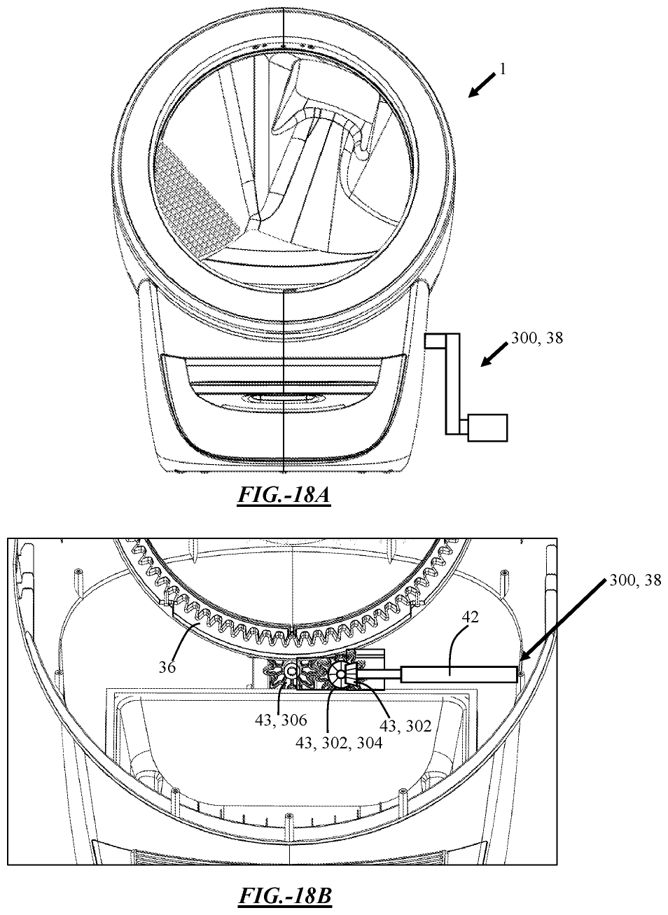

FIGS. 18A-18B illustrate a litter device 1. The litter device 1 includes a hand crank 300. The hand crank 300 is part of a drive source 38. The hand crank 300 is in rotational communication with a drive shaft 42. A hand crank 300 may be used in lieu of a motor 40. The hand crank 300 may include a drive shaft 42. The drive shaft 42 may be in rotatable communication with a plurality of gears 43. The plurality of gears 43 may include straight bevel gears 302. One of the gears 43 may be a stepped gear 304. One or more of the gears 43 may be pinion gears 306. One of the gears 43 mates with the track 36. Rotation of a hand crank 300 transfers torque to a plurality of gears 43. The plurality of gears 43 transfer torque to the track 36. The track 36 rotates the chamber 10 (not shown).

FIGS. 19A-19C illustrate a litter device 1. The litter device 1 includes a chamber 10, base 12, and litter dispenser 200. The litter dispenser 200 is affixed to the chamber 10. The litter dispenser 200 is affixed to a bonnet 14. The litter dispenser 200 is located opposite the opening 22 of the chamber 10.

FIGS. 20A and 20 B illustrate a litter device 1. The litter device 1 includes a lift 150. The lift 150 is affixed to or integrated with the base 12. The litter device 1 includes a user interface 190. The user interface 190 is affixed to a bezel 24. The user interface 190 includes a plurality of user inputs 191. The user interface 190 includes a screen 193. The litter device 1 includes a speaker 194. The speaker 194 is affixed to the bezel 24. The litter device 1 includes a microphone 195. The microphone 195 is affixed to the bezel 24. The litter device 1 includes a litter dispenser 200.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A litter device comprising:
a) a base;
b) a waste bin removably located within the base;
c) a chamber with an entry opening, wherein the chamber is configured to retain a litter, is rotatably supported by the base, and configured to come into fluid communication with the waste bin; and
d) a drive source configured to rotate the chamber during a cleaning cycle of the litter device, wherein the drive source is manual.

2-20. (canceled)

21. The litter device of claim 1, wherein the drive source transfers a manually applied mechanical force to the chamber such as to rotate the chamber.

22. The litter device of claim 21, wherein the drive source includes a hand crank.

23. The litter device of claim 22, wherein the drive source is in rotatable communication with one or more gears.

24. The litter device of claim 23, wherein the one or more gears are engaged with a track.

25. The litter device of claim 24, wherein the track encircles an outside wall of the chamber.

26. The litter device of claim 25, wherein the track lies in a track plane which is offset from both a horizontal plane and vertical plane.

27. The litter device of claim 25, wherein the track includes a gear, teeth, or both.

28. The litter device of claim 27, wherein the hand crank is movably affixed to the base and extends outward away from an interior of the base.

29. The litter device of claim 28, wherein the hand crank is in rotatable communication with and/or includes a drive shaft.

30. The litter device of claim 29, wherein the drive shaft is in rotatable communication with the one or more gears.

31. The litter device of claim 30, wherein the one or more gears includes one or more pinion gears engaged with the track.

32. The litter device of claim 31, wherein the one or more gears includes a plurality of gears, and one or more additional gears are located between the one or more pinion gears and the drive shaft.

33. The litter device of claim 30, wherein rotation of the hand crank transfers torque to the one or more gears which then transfer torque to the track and result in rotation of the chamber such that a waste opening of the chamber aligns with the waste bin.

34. A litter device comprising:
a) a base;
b) a waste bin removably located within the base;
c) a chamber with an entry opening, wherein the chamber is configured to retain a litter, is rotatably supported by the base, and configured to come into fluid communication with the waste bin;
d) a track which encircles an outside wall of the chamber;
e) a drive source configured to rotate the chamber during a cleaning cycle of the litter device, wherein the drive source is manual and free of requiring an electronic power source, wherein the drives source includes:
i) a hand crank moveably affixed to the base and extending outward away from an interior of the base;
ii) one or more gears in rotatable communication with both the hand crank and the track; and
iii) a drive shaft between the hand crank and the one or more gears.

35. The litter device of claim 34, wherein the track lies in a track plane which is offset from both a horizontal plane and vertical plane.

36. The litter device of claim 35, wherein the one or more gears includes one or more pinion gears engaged with the track.

37. The litter device of claim 36, wherein the one or more gears includes a plurality of gears, and one or more additional gears are located between the one or more pinion gears and the drive shaft.

38. The litter device of claim 37, wherein the one or more additional gears include one or more bevel gears.

39. The litter device of claim 38, wherein the one or more additional gears include one or more stepped gears.
